(19) United States
(12) Patent Application Publication
(10) Pub. No.: US 2026/0268576 A1
(43) Pub. Date: Sep. 10, 2026

(54) GRAPHICS PROCESSING

(71) Applicant: Arm Limited, Cambridge (GB)

(72) Inventors: ANDREAS DUE ENGH-HALSTVEDT, Trondheim (NO); Mark UNDERWOOD, Cambridge (GB)

(73) Assignee: Arm Limited, Cambridge (GB)

(21) Appl. No.: 19/073,755

(22) Filed: Mar. 7, 2025

(51) Int. Cl. G06T 15/00; G06T 1/20; G06T 1/60

(52) U.S. Cl. CPC G06T 15/005; G06T 1/20; G06T 1/60

(57) ABSTRACT

When performing a tile-based rendering process to generate a render output, a geometry processing part of a graphics processor provides an indication to a fragment processing part of the graphics processor to perform a render for the render output being generated. The indication to perform the render is associated with metadata that can be set be set to indicate that the render to be performed is a first render to be performed for the render output that is being generated, and with metadata that can be set to indicate that the render to be performed is a final render to be performed for the render output that is being generated. In response to the indication, the fragment processing part performs a render for the render output being generated, in accordance with the metadata.

### BACKGROUND

The technology described herein relates to graphics processing, and in particular to tile-based graphics processing.

Graphics processing is normally carried out by first splitting a scene (e.g. a 3D model) to be rendered (e.g. for display) into a number of similar basic components or “primitives”, which primitives are then subjected to the desired graphics processing operations. The graphics primitives are usually in the form of simple polygons such as triangles, quadrilaterals, points, lines or groups thereof.

Each primitive is usually defined by and represented as a set of vertices (e.g. three vertices in the case of a triangular primitive). The vertices that are to be used for the primitives will have respective sets of vertex data defining the vertices, e.g. the relevant attributes for each of the vertices. These attributes will typically include position data and other, non-position data (varyings), e.g. defining colour, light, normal, texture coordinates, etc., for the vertex in question.

In tile-based graphics processing, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles). The tiles are each rendered separately (e.g. one after another). The rendered tiles are then combined to provide the complete render output (e.g. frame for display).

Tile-based graphics processing will normally include some geometry processing, followed by rendering (fragment processing).

The geometry processing typically includes initial processing such as vertex processing (vertex shading) of attributes for vertices to be used for primitives for the render output being generated, to generate intermediate geometry (and other) data (e.g. shaded vertex data) required for rendering the graphics processing output. The geometry processing may also include a tiling/binning process for determining which geometry (e.g. primitives) needs to be processed for respective rendering tiles of the output being generated.

(In tile-based graphics processing, it is usually desirable to be able to (try to) identify the geometry (e.g. primitives) for the render output that need to be processed for a given rendering tile (so as to avoid unnecessarily processing geometry that does not actually apply to a rendering tile). To facilitate this, in tile-based graphics processing, there is usually a tiling/binning process that is performed that generates appropriate data structures, such as lists of primitives that apply to a tile or tiles, for use then to identify geometry that need to be processed for a respective rendering tile.)

Once the geometry processing has been performed the geometry can be rendered by subjecting the result of the geometry processing to appropriate rendering/fragment processing. This may comprise, for example, rasterising primitives to be processed to fragments, fragment shading of the fragments, and/or performing ray tracing operations. This operation is performed on a tile-by-tile basis (with the result of the tiling/binning process being used to identify the geometry (e.g. primitives) that need to be processed for a respective rendering tile).

The rendered tiles may then be combined appropriately to provide the overall render output (e.g. frame for display).

In “normal” tile-based graphics processing, the geometry processing is carried out to completion (i.e. for all of the geometry (primitives) for the render output being generated) in a (single) geometry processing pass, with a (single) “full” render then being carried out by the fragment processing using the result of the geometry processing (pass), to generate the (full) render output.

However, in some cases, a so-called “incremental” rendering process may instead be used, wherein a sequence of plural “incremental” renders is performed in order to generate the (overall) render output.

In this case, the geometry processing may be carried out as a sequence of plural “partial” geometry processing passes, wherein in each of these geometry processing passes a subset (but not all) of the geometry (e.g. primitives) to be processed for the render output is subjected to geometry processing. Plural respective “incremental” renders are performed by the rendering/fragment processing using the results of each of the partial geometry processing passes, to generate the (full) render output.

Incremental rendering may be carried out when “normal” tile based graphics processing is not possible, e.g. because the geometry processing is unable to subject all of the geometry to be processed for the render output being generated to geometry processing in a single pass. For example, incremental rendering may be triggered if the geometry processing runs out of memory to store the intermediate geometry (and other) data generated during geometry processing.

Thus, when generating a render output, geometry processing may progress until such an out of memory event is encountered, at which point this (first) geometry processing pass is ended and a (first) incremental render is performed by the fragment processing (using the result of the first geometry processing pass, including intermediate geometry, etc.). The intermediate geometry (and other) data generated during the first geometry processing pass is no longer required and can therefore be discarded, thereby releasing memory for the geometry processing to continue with geometry processing in another pass (either until geometry processing is completed for the render output being generated or until another out of memory event is encountered, etc., and so on).

Typically, incremental rendering is handled by an exception handler in software (e.g. which triggers when an out of memory event is encountered by the geometry processing) that configures the incremental render to be performed by the fragment processing, and then ensures that memory is released back to the geometry processing.

The Applicants believe that there remains scope for improvements to tile-based processing when carrying out incremental rendering.

### BRIEF DESCRIPTION OF THE DRAWINGS

A number of embodiments of the technology described herein will now be described by way of example only and with reference to the accompanying drawings, in which:

FIG. 1 shows an exemplary data processing system in which the technology described herein may be implemented;

FIG. 2A shows an exemplary graphics processing pipeline when performing a normal (“full”) render to generate a render output;

FIG. 2B shows an exemplary graphics processing pipeline when performing multiple incremental renders to generate a render output;

FIG. 3 shows schematically a graphics processor that may be operated in accordance with the technology described herein;

FIG. 4 shows an overview of data structures used in graphics processing operations an embodiment of the technology described herein;

FIG. 5 shows a tiler heap chunk an embodiment of the technology described herein;

FIG. 6 is a flowchart of the operation of the graphics processor when a normal “full” render is carried out an embodiment of the technology described herein;

FIG. 7 is a flowchart of the operation of the graphics processor when multiple incremental renders are carried out an embodiment of the technology described herein; and

FIG. 8 is a flowchart of a fragment processing pipeline an embodiment of the technology described herein.

### DETAILED DESCRIPTION

A first embodiment of the technology described herein comprises a method of operating a graphics processor to execute a tile-based rendering process to generate a render output, the tile-based rendering process comprising a geometry processing part wherein geometry processing is performed for a render output being generated, and a fragment processing part wherein the result of the geometry processing by geometry processing part is subjected to fragment processing to render tiles of the render output being generated, the method comprising:
the geometry processing part providing an indication to the fragment processing part to perform a render for a render output being generated, the indication being associated with metadata that can be set to indicate that the render to be performed is a first render to be performed for the render output that is being generated, and with metadata that can be set to indicate that the render to be performed is a final render to be performed for the render output that is being generated; and
the fragment processing part, in response to the indication, performing a render for the render output being generated in accordance with the metadata.

A second embodiment of the technology described herein comprises a graphics processor configured to execute a tile-based rendering process to generate a render output, the graphics processor comprising:
one or more geometry processing circuits configured to perform geometry processing for a render output being generated; and
one or more fragment processing circuits configured to subject the result of geometry processing to fragment processing to render tiles of a render output;
wherein the geometry processing circuits comprise a processing circuit configured to provide an indication to the fragment processing circuits to perform a render for a render output being generated, the indication being associated with metadata that can be set to indicate that the render to be performed is a first render to be performed for the render output that is being generated, and with metadata that can be set to indicate that the render to be performed is a final render to be performed for the render output that is being generated;
and wherein the fragment processing circuits comprise a processing circuit configured to, in response to the indication, cause a render for the render output being generated to be performed in accordance with the metadata.

The technology described herein relates to tile-based graphics processing. The graphics processing includes a geometry processing part wherein geometry processing is performed for a render output that is being generated. A fragment processing part performs rendering using the results of the geometry processing to render the tiles of the render output.

In the technology described herein, the geometry processing (part) provides an indication to the fragment processing (part) to perform a render (using the results of the geometry processing). The indication is associated with metadata that can be set (i.e. is settable) to indicate that the render to be performed is a first render to be performed for (i.e. in respect of) the render output being generated, and also with metadata that can be set (i.e. is settable) to indicate that the render to be performed is a final render to be performed for (i.e. in respect of) the render output being generated. The fragment processing part then performs the render that is indicated (in response to the indication sent by the geometry processing part) in accordance with the metadata (and, particularly, the way the metadata is set).

As will be discussed further below, the metadata of the technology described herein (in being settable to indicate when the render is the first and/or last render) is sufficient to specify to the fragment processing part whether the render that is indicated to be performed by the fragment processing part is either (a) a normal “full” render for the render output being generated, or (b) an incremental render in a sequence of incremental renders for the output being generated (and, in the case of (b), whether the incremental render is (i) the first, (ii) the last, or (iii) neither the first nor the last (i.e. an intermediate) incremental render in the sequence of incremental renders being performed for the render output). The metadata provided in the indication therefore allows the fragment processing part to configure itself to correctly carry out the render according to the type of render (listed above) that is indicated to be performed.

Thus, the technology described herein effectively provides a framework for efficiently triggering and performing renders in a graphics processor which can be used for both “normal” and “incremental” renders (without requiring, e.g., separate software to handle the incremental rendering case). Further, since the geometry processing (part) provides the indication to perform rendering and the fragment processing (part) responds to the indication (directly), the process for triggering and performing renders can be carried out entirely by the graphics processing hardware (and without requiring any software intervention).

The Applicants have also recognised that there may be circumstances where it could be beneficial to trigger an (e.g. incremental) render (even if, e.g., the conditions that may normally result in an incremental render, e.g. an out of memory event during geometry processing, have not been met). The technology described herein advantageously provides a framework wherein incremental renders can be triggered if and when is desired.

The technology described herein therefore provides a means for efficiently and flexibly carrying out renders (both normal (“full”) and incremental) in a tile-based graphics processor.

The geometry processing (part) of the technology described herein can comprise any suitable and desired graphics processing stages that may be performed as part of a geometry processing pipeline.

In an embodiment, the geometry processing (part) comprises one or more of, and in an embodiment plural of, the following geometry processing stages (and the geometry processing circuit(s) are configured to perform): a position shader (position shading); a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback shader (transform feedback shading). The geometry processing may comprise one or more of these shader stages, as desired.

In an embodiment, the geometry processing (part) comprises a tiling/binning stage (circuit) that generates data structures to be used to determine which geometry needs to be processed for respective tiles of a render output. In an embodiment, the tiling/binning stage (circuit) follows one or more of the “early” geometry processing stages listed above. In an embodiment, the tiling/binning stage uses (e.g. transformed) positional geometry data generated by the one or more “initial” geometry processing stages to generate data structures that allow the geometry that needs to be processed for respective rendering tiles of the render output to be identified. The data structures allowing geometry to be processed for respective rendering tiles to be identified could comprise any suitable such data structures, e.g. lists of primitives which indicate the primitives to be processed for respective tiles or sets of tiles of the render output, hierarchies of bounding boxes, etc., and so on.

In an embodiment, the geometry processing is carried out by executing a geometry (command) stream which has been built up (and provided) by a host processor, wherein the geometry (command) stream comprises one or more instructions to execute one or more geometry processing operations (e.g. stages) (e.g. as discussed above).

The fragment processing uses the result of the geometry processing to process fragments and render tiles of the render output that is being generated (i.e. perform a render), e.g. (and in an embodiment) by subjecting primitives to rendering/fragment processing operations.

The result of the geometry processing which is used by the fragment processing may comprise any data generated by the geometry processing part (in a geometry processing pass that is performed). For example, the result of the geometry processing could comprise (e.g. transformed) geometry data (e.g., and in an embodiment, shaded vertex position data and non-positional geometry data), data structures identifying geometry to be processed for respective tiles (generated by the tiling/binning stage), etc., and so on.

The rendering/fragment processing operations performed by the fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

In an embodiment, the fragment processing is carried out by executing a fragment (command) stream which has been built up (and provided) by a host processor, wherein the fragment (command) stream comprises one or more instructions to execute one or more fragment processing operations (e.g. stages), (e.g. as discussed above).

In the technology described herein, an indication to perform a render is provided to the fragment processing part by the geometry processing part. The indication (to perform a render) can have any suitable and desired form. In an embodiment, the indication is associated with a particular render (operation) that is to be performed (by the fragment processing part). For example, the indication could (and in some embodiments does) contain an identifier for (i.e. that is associated with) a particular render that is to be performed.

In an embodiment, the indication is sent when it is determined that it would be beneficial and/or necessary for the fragment processing part to perform a render.

For example, the indication to perform a render may be (and in an embodiment is) provided to the fragment processing part when it is determined that geometry processing in respect of (i.e. for) the render output being generated is completed (e.g. because all of the geometry for the render output being generated has been processed by geometry processing). Thus, in an embodiment, when a geometry processing pass being performed completes processing all the (remaining) geometry for a render output, this triggers the sending of the indication (by the geometry processing part to the fragment processing part) to perform a render.

The indication to perform a render could (e.g. also) be provided to the fragment processing part when suitable and/or desired criteria has been reached as geometry processing progresses, before geometry processing is completed (in respect of the render output being generated).

In embodiments, the indication to perform a render is provided to the fragment processing based on a shortage of memory being available to the geometry processing part (i.e. a so-called “out of memory event” occurring) for storing the results of geometry processing. Thus, in an embodiment, when it is determined during a geometry processing pass that there is a shortage of memory available for storing results of geometry processing, this triggers the sending of the indication (by the geometry processing part to the fragment processing part) to perform a render (and in an embodiment the termination of the geometry processing pass being performed).

As will be understood, as geometry processing progresses (in a geometry processing pass), the result of the geometry processing (i.e. data generated during geometry processing, as discussed above) is stored in memory such that it can (later) be used by the fragment processing when performing rendering. As geometry processing progresses, more and more data will be stored to memory in this way. At some point (during geometry processing), the memory required to store the results of (further) geometry processing may approach (or exceed) the memory that is available. It can therefore be beneficial to (e.g. terminate the geometry processing pass being performed and) trigger a render (based on the results of the geometry processing (pass) which have been stored to memory) when (or before) this point is reached (i.e. before there is no more memory available to store results of further geometry processing).

Thus, in embodiments, the indication to perform a render is provided (by the geometry processing part) when the (amount of) memory used for storing the results of the geometry processing (e.g. is equal to or) exceeds a (e.g. selected, e.g. predetermined) memory usage threshold, and/or (correspondingly) when the (amount of) remaining memory that is still available for storing results of geometry processing (e.g. is equal to or) is less than a (e.g. selected, e.g. predetermined) memory availability threshold.

The threshold(s) may correspond to a particular (e.g. selected, e.g. predetermined) amount of units of memory (e.g. a number of bytes). Alternatively, the threshold(s) may be (and in an embodiment are) based on the (total) amount of memory available to the geometry processing part for storing the results of geometry processing.

For example, in an embodiment, the memory usage threshold may directly correspond to the (total) amount of memory that is available to the geometry processing part, such that the indication to perform the render is provided when the memory used for storing the results of the geometry processing (e.g. is equal to or) exceeds the (total) amount of memory that is available to the geometry processing (i.e. such that the geometry processing part can be said to have “run out” of memory for storing results of geometry processing).

In another embodiment, the memory usage threshold may correspond to a portion of the (total) amount of memory available to the geometry processing part for storing geometry processing results (e.g. such that the indication to perform the render is provided when memory used for storing the results of the geometry processing (e.g. is equal to or) exceeds a particular, in an embodiment selected, in an embodiment predetermined amount (e.g. 90%) of the (total) amount of memory available to the geometry processing part for storing geometry processing results).

Similarly (and correspondingly), in an embodiment, the memory availability threshold may correspond to a portion of the (total) amount of memory available to the geometry processing part for storing geometry processing results (e.g. such that the indication to perform the render is provided when remaining memory available for storing the results of the geometry processing (e.g. is equal to or) is less than a particular, in an embodiment selected, in an embodiment predetermined amount (e.g. 10%) of the (total) amount of memory available to the geometry processing part for storing geometry processing results).

The amount of memory that is being used for storing results of geometry processing and/or the amount of remaining memory that is still available for storing results of geometry processing could be (and an in embodiment is) determined periodically during the geometry processing (pass) being performed (to check whether the criteria for triggering the sending of the indication to perform a render has been reached). In an embodiment, the amount of memory being used and/or remaining is determined periodically after a particular (in an embodiment selected, in an embodiment predetermined) number of (processing) cycles.

The indication to perform a render could (also or instead) be provided to the fragment processing part at other times during geometry processing, e.g. at times when it may be deemed beneficial to perform an (incremental) render on the basis of the geometry processing results that have been so far generated (in the geometry processing pass performed). For example, a render could be triggered (by providing the indication to perform a render to the fragment processing part) if there are specific fragment-to-fragment side effect dependencies, explicit processing barriers, incompatible features being used, etc., and so on. For example, the applicants have recognised that in certain circumstances there may be (e.g. one or more of) incompatible features, processing barriers, side effects, dependencies (etc., and so on) that mean it is beneficial (or necessary) to trigger a render out of the normal sequence for doing so, and the technology described herein provides a mechanism for doing this.

In these embodiments, the providing of the indication to perform a render is in an embodiment “actively” triggered, e.g. by the execution of an explicit instruction to provide the indication (in contrast to, e.g., the case described above, wherein the indication to perform a render is “passively” triggered when a lack of memory is detected). The (active) triggering to provide the indication to perform the render can take any suitable or desired form. For example, in embodiments wherein the geometry processing is carried out by executing a geometry (command) stream which has been built up (and provided) by a host processor, the geometry (command) stream could comprise one or more explicit instructions (to “do (incremental) rendering now”) which, when executed, cause the geometry processing to provide an indication to perform a render to the fragment processing part (of the geometry processor).

In the technology described herein, the indication to perform a render (that is provided to the fragment processing part by the geometry processing part) is associated with (first) metadata that can be set to indicate that the render to be performed is a first render to be performed for the render output that is being generated, and with (second) metadata that can be set to indicate that the render to be performed is a final render to be performed for the render output that is being generated. This metadata can be provided in any suitable or desired form.

In embodiments, the (and in an embodiment each) metadata comprises a Boolean flag. Thus, in embodiments, the indication is associated with a first flag (metadata) which can be set to set to true or false according to whether or not the render to be performed is a first render to be performed for the render output that is being generated, and a second flag (metadata) which is set to true or false according to whether or not the render to be performed is a final render to be performed for the render output that is being generated. Other arrangements for the metadata would, of course, be possible.

As mentioned above, the metadata of the technology described herein is sufficient to specify the type of render to be performed by the fragment processing, i.e. whether the render to be performed is (a) a normal “full” render for the render output being generated (i.e. based on a single, full, geometry processing pass), or (b) an incremental render in a sequence of incremental renders for the output being generated (and, in the case of (b), whether the incremental render is (i) the first, (ii) the last, or (iii) neither the first nor the last (i.e. an intermediate) incremental render in the sequence of incremental renders being performed for the render output).

The (first and second) metadata of the technology described herein can in an embodiment be set in (at least, and in an embodiment exactly) four combinations corresponding to each of these four types of renders to be performed, such that each any of these four types of renders can be indicated (to the fragment processing part) (with the fragment processing part then proceeding to perform the render in accordance with the type of render being indicated, as will be discussed further below).

In embodiments, the geometry processing (part) provides an indication to the fragment processing part to perform a normal (“full”) render when the (first) metadata (associated with the indication) indicates that the render to be performed is a first render (for the render output), and the (second) metadata (associated with the indication) indicates that the render to be performed is (also) a final render (for the render output).

Further, in embodiments, the geometry processing (part) provides an indication to the fragment processing part to perform a first incremental render in a series of incremental renders for the render output being generated when the (first) metadata (associated with the indication) indicates that the render to be performed is a first render (for the render output), but the (second) metadata (associated with the indication) other than indicates (does not indicate) that the render to be performed is a final render (for the render output).

Further, in embodiments, the geometry processing (part) provides an indication to the fragment processing part to perform a final incremental render in a series of incremental renders for the render output being generated when the (first) metadata (associated with the indication) other than indicates (does not indicate) that the render to be performed is a first render (for the render output), and the (second) metadata (associated with the indication) indicates that the render to be performed is a final render (for the render output).

Further, in embodiments, the geometry processing (part) provides an indication to the fragment processing part to perform an intermediate (i.e. not the first but also not the last) incremental render in a series of incremental renders for the render output being generated when the (first) metadata (associated with the indication) other than indicates (does not indicate) that the render to be performed is a first render (for the render output), and the (second) metadata (associated with the indication) other than indicates (does not indicate) that the render to be performed is a final render (for the render output).

In an embodiment, the (first and last) metadata is set by the geometry processing part (and in an embodiment by a tiling/binning stage of the geometry processing part). The (first and last) metadata is in an embodiment set according to the type of geometry processing pass(es) performed for the render output by the geometry processing part (prior to sending the indication, i.e. that “triggers” the sending of the indication).

More particularly, the first metadata is in an embodiment set according to whether or not the geometry processing (pass) performed (that “triggers” the sending of the indication) is a first geometry processing pass that is performed for the render output. The second metadata is in an embodiment set according to whether or not the geometry processing for the render output has been carried out to completion in the geometry processing pass being performed (i.e. according to whether or not the geometry processing pass that “triggers” the sending of the indication is a final geometry processing pass for the render output being generated).

Thus, in embodiments, the (first) metadata is set (and thus the process in an embodiment includes the geometry processing part setting the metadata) to indicate that the render to be performed is a first render for the render output being generated when the geometry processing pass that “triggers” the (sending of the) indication is a first geometry processing pass that is performed in respect of the render output that is being generated, and/or (correspondingly) the (first) metadata is set (and thus the process in an embodiment includes the geometry processing part setting the metadata) to indicate that the render to be performed is not a first render for the render output being generated when the geometry processing pass that “triggers” the (sending of the) indication is a subsequent graphics processing pass for the render output being generated (i.e. if a geometry processing pass has already been performed for the render output).

In embodiments, the (second) metadata is set (and thus the process in an embodiment includes the geometry processing part setting the metadata) to indicate that the render to be performed is a final render for the render output being generated when the geometry processing for the render output has been carried out to completion (which, as will be understood (and as discussed above), indicates that the geometry processing pass is the final geometry processing pass for the render output being generated), and/or (correspondingly), the (second) metadata is set (and thus the process in an embodiment comprises the geometry processing part setting the metadata) to indicate that the render output to be performed is not a final render for the render output being generated when the geometry processing for the render output has not (yet) been carried out to completion (and hence a render is being triggered before (all) geometry processing for the render output has been completed, e.g. because an “out of memory” event occurs (as discussed above)).

In embodiments (discussed above) wherein the (first) metadata comprises a first flag (that can be set to indicate that the render to be performed is a first render for the render output being generated), in an embodiment the geometry processing part sets the first flag when beginning a first geometry processing pass for the render output being generated, and in an embodiment the geometry processing part unsets (i.e. clears) the first flag after the (first) indication to perform a render (for the render output in question) has been sent.

Similarly, in embodiments (discussed above) wherein the (second) metadata comprises a second flag (that can be set to indicate that the render to be performed is a final render for the render output being generated), the geometry processing part in an embodiment sets the second flag (only) once geometry processing in respect of the render output being generated has been completed, and in an embodiment (if necessary) unsets (clears) the second flag (if it is not already unset (cleared)) when sending an indication to perform a render at any time before geometry processing in respect of the render output being generated has been completed (e.g. due to an out of memory event being encountered, as described above).

The indication to perform a render is sent by the geometry processing (part), and, in an embodiment, by a tiling/binning stage (e.g. tiler, tiler iterator) of the geometry processing part. In an embodiment, the tiler is triggered to send the indication to perform a render when the criteria for doing so (e.g. geometry processing completed, out of memory event, etc., as discussed above) is reached in a geometry processing pass.

The indication to perform a render can be provided (i.e. sent) to the fragment processing (part) by the geometry processing (part) in any suitable or desired manner. For example, the indication could be provided using a semaphore shared between the geometry processing (part) and the fragment processing (part).

In embodiments, however, the indication to perform a render is provided to the fragment processing via a queue, and in an embodiment a (single) FIFO (first in first out) queue, that is provided (and shared) between the geometry processing and fragment processing parts. In an embodiment, the FIFO is implemented in hardware (although it could be implemented in software instead, if desired).

In an embodiment, the providing of the indication comprises the geometry processing part (and in an embodiment, the tiling/binning stage of the geometry processing part) adding the indication to the (e.g. FIFO) queue (populating an entry in the (e.g. FIFO) queue with the indication (to perform the render)) (when a geometry processing pass that is performed triggers it to do so, as discussed above).

The fragment processing part then in an embodiment receives the indication (to perform the render) by retrieving (reading) the indication to perform the render from the (e.g. FIFO) queue. In an embodiment, once the fragment processing part has retrieved (read) the indication from the queue, the fragment processing part releases the entry in the queue used to store in the indication (e.g. such that the entry can be re-used to store a another (further) indication to perform a render (that is subsequently added by the geometry processing part).

In an embodiment, the queue is able to store (i.e. has sufficient entries for storing) a plurality of indications to perform a render (that are added to the queue by the geometry processing part, as discussed above), although this need not necessarily be the case, and it would be possible for the queue to only be able to store a single indication, for example. When adding an indication to the queue (and in a case wherein the queue already contains (previously added) indications), the geometry processing part in an embodiment adds the indication to the back of the queue.

In embodiments, the queue has a limited (storage) capacity, such that it can store a (e.g. selected, e.g. predetermined) maximum number of indications (that are added by the geometry processing part).

In these embodiments, there may be circumstances in which the geometry processing part is triggered to (attempt to) send the indication to perform a render, but the queue is already filled to capacity with (previously added) indications (i.e. such that there is no available space in the queue for a further indication to be added). The geometry processing may therefore have to “wait” until space becomes available in the queue (e.g. when the fragment processing part reads an indication that is already stored in the queue and releases the queue entry, as discussed above) before it is able to successfully add the indication to the queue

In this case, the geometry processing part is in an embodiment configured to continue attempting to add the indication to the queue (e.g. periodically), until it is able to successfully do so (when space becomes available in the queue).

As discussed above, the fragment processing retrieves (reads) an indication to perform a render from the queue (and that has been added to the queue by the geometry processing part). In an embodiment (e.g. in cases wherein the queue stores plural indications), the fragment processing retrieves (reads) an indication from the front of the queue.

In an embodiment, the fragment processing part is configured to check for an indication (to check the queue) and attempt to retrieve an indication to perform a render) (at the front of the queue), e.g. and in an embodiment at appropriate intervals/events. This can be achieved in a any suitable or desired manner.

In an embodiment, a fragment (command) stream (that is in an embodiment built up (and provided) by a host processor), which in an embodiment comprises fragment processing commands to execute fragment processing operations (as discussed above), (also) comprises appropriate command(s) which, when executed, trigger the fragment processing to (attempt to) retrieve an indication to perform a render from the queue.

Thus, in these embodiments, the graphics processor executes the fragment (command) stream including the appropriate command(s), and the fragment processing part, in response to the appropriate command(s) being executed, checks (the front of) the queue and (if an indication is present) retrieves (reads) the indication from (the front of) the queue (with the fragment processing part then in an embodiment proceeding to perform fragment processing operations (i.e. a render) in response to fragment processing commands (of the fragment (command) stream being executed).

There may be circumstances in which the fragment processing is triggered to check (the front of) the queue and attempt to retrieve an indication therefrom (and hence the fragment processing is “ready” to perform a render once an indication to do so is received), but no indication to perform a render has yet been provided by geometry processing (e.g., because geometry processing is still being carried out), and hence there may be no indication (the queue may be empty) when the fragment processing checks it and attempts to retrieve its contents. The fragment processing may therefore have to “wait” until the fragment processing adds the indication (to the queue).

The fragment processing is therefore in an embodiment configured to continue checking for an indication (the queue) (e.g. periodically) until the geometry processing part provides the indication (populates the queue with the indication) to perform a render (and hence an indication to perform a render can be retrieved by the fragment processing). In an embodiment, the fragment processing flow is “stalled” (i.e. doesn't continue) until an indication to perform a render is successfully received (fetched from the queue) (by the fragment processing).

Thus, in embodiments (discussed above), wherein the fragment processing part is triggered to check (and attempt to retrieve an indication from) (the front of) the queue in response to appropriate command(s) to do so in a fragment (command) stream being executed, in cases wherein there is no indication present in the queue, the fragment processing is in an embodiment triggered (in response to the execution of said appropriate command(s) in the fragment (command) stream) to continue periodically checking (and attempting to retrieve an indication from) the queue, until able to successfully do so.

Once the fragment processing does retrieve the indication to perform the render, this in an embodiment triggers the fragment processing to perform (i.e. begin performing) a render (in accordance with the indication).

The Applicants have recognised that providing the indication to perform a render via a (FIFO) queue (shared between geometry processing and fragment processing) in this way can (automatically) make sure that geometry processing and fragment processing (i.e. rendering) operations are performed in the right order. Thus, the (FIFO) queue effectively provides an appropriate synchronisation mechanism between the geometry processing and fragment processing on its own, without requiring something else (e.g. separate software) to oversee this.

The indication to perform a render in the technology described herein is associated with metadata (as described above). In an embodiment, the indication to perform the render comprises the metadata directly, i.e. such that the indication itself that is provided to the fragment processing part also contains the metadata. (For example, in embodiments described above, wherein the indication to perform a render is provided to the by populating an entry in a (FIFO) queue, the entry in an embodiment contains the metadata). However, this need not necessarily be the case, and the metadata could (e.g. instead) be located (stored) separately from the indication to perform a render that is provided to the fragment processing by the geometry processing.

The indication to perform a render could also comprise other data (e.g. data that could be used by the fragment processing part when performing the render). For example, the indication could comprise (e.g. state) information relating to how the rendering should be performed by the fragment processing stage, e.g., whether or not use ray tracing, configuration information for specific shaders, etc., and so on.

The indication to perform a render could itself also or instead comprise (state) information that allows the render to be performed. The (state) information may comprise any suitable data that is necessary for the fragment processing part in order to correctly perform the render that is required. The (state) information may comprise, e.g. (and in an embodiment), one or more of: the size of the render output to be generated, the size of the tiles, colour depth etc., and so on.

In an embodiment, however, rather than including (all) necessary state information in the indication to perform a render itself, (state) information is stored to memory (in an embodiment by the geometry processing, and in an embodiment a tiling/binning stage (e.g. tiler, tiler iterator) of the geometry processing), with the indication containing a pointer (i.e. memory address) that can be used (by the fragment processing part) to locate (and retrieve) the (state) information in memory.

In embodiments, the (state) information is contained in a descriptor. Thus the descriptor in an embodiment comprises the (state) information, in an embodiment as one or more attributes of the descriptor (which are read by the fragment processing stage).

In an embodiment, the pointer is a pointer to the (exact) location in memory where the (state) information (e.g. descriptor) is stored. The pointer could, however, be a pointer to a different location in memory from the memory location at which the state information (e.g. descriptor) is stored, from which the fragment processing can (and in an embodiment does) derive the location in memory where the state information (e.g. descriptor) is stored.

The (state) information (e.g. descriptor) is in an embodiment generated (and allocated memory and stored to memory) by the geometry processing part, and in an embodiment by a tiling/binning stage/circuit (tiler) of the geometry processing part (with the (e.g. tiling/binning stage/circuit of the) geometry processing part then sending an indication to fragment processing part to perform a render that contains a pointer that can be used by the fragment processing part to locate the descriptor).

Thus, an embodiment of the technology described herein, the process comprises (e.g. and in an embodiment a tiling/binning stage/circuit of) the geometry processing part generating and storing to memory a descriptor comprising information for allowing a render to be performed, and providing a pointer in the indication to perform a render that is provided to fragment processing part, wherein the pointer is usable to locate the descriptor in memory; and the fragment processing part using the pointer to retrieve the descriptor from memory, and performing the render for the render output being generated using the information (in the descriptor).

In an embodiment the geometry processing part generates a (new) descriptor at the start of a new geometry processing pass that is performed. In an embodiment, a new descriptor is generated at the start of (and in respect of) each geometry processing pass that is (to be) performed.

In some graphics processing systems, a descriptor (comprising (state) information which allows a render to be performed) is generated by software (e.g. a driver) running on the host processor (for the intended purpose of providing this (state) information to fragment processing). In embodiments of the technology described herein, wherein such a software-generated descriptor is present, the geometry processing part in an embodiment generates its descriptor based on (using) the software-generated descriptor, e.g. by copying (some or all of) its attributes.

Thus, in an embodiment, when generating the descriptor, the geometry processing part determines attributes for the descriptor based on an earlier-generated descriptor that has (already) been generated by software running on the host processor (wherein the earlier-generated descriptor is generated by software for the intended purpose of providing (render state) information to the fragment processing part).

The Applicants have recognised that, by using a descriptor that is generated by the geometry processing part and accessed by the fragment processing part (such that the entire lifetime of the descriptor can be handled by the graphics processor (e.g. only)), this allows data contained in the descriptor (and the location in memory of the descriptor itself) to be handled by the graphics processor exclusively, without having the burden of needing to maintain or update this for, e.g., software running on the host processor (regardless of whether a “normal” (i.e. full) rendering pass or whether plural incremental rendering passes are being performed).

As discussed above, in embodiment of the technology described herein, when a new geometry processing pass is being performed, the geometry processing part generates and stores to memory a new descriptor for the geometry processing pass (comprising (render state) information). Geometry processing is then performed (by the geometry processing part), with results of the geometry processing being stored to memory.

The results of the geometry processing could be stored in any suitable or desired location in memory. In embodiments of the technology described herein, however, the results of the geometry processing are stored to memory at location(s) that are identifiable based on the descriptor (or the location in memory thereof). The pointer that is provided to the fragment processing part by the geometry processing part (as part of the indication to perform a render) can then be used by the fragment processing part to not only locate and retrieve and the descriptor, but also the results of the geometry processing.

Thus in an embodiment of the technology described herein, the process comprises the geometry processing part storing the results of the geometry processing in memory at a location that is identifiable from the descriptor, and the fragment processing parts using the pointer to retrieve the results of the geometry processing and subjecting them to fragment processing when performing the render for the render output being generated

The descriptor could itself comprise data that indicates where in memory the results of the geometry processing is stored, such that the fragment processing can read the descriptor and use this data to locate the results of the geometry processing.

In embodiments of the technology described herein, however, the results of the geometry processing are stored at a (e.g. selected, e.g. predetermined) location in memory relative to the location at which the descriptor is stored, such that the fragment processing can determine the location at which the results of the geometry processing are stored based on the location at which the descriptor is stored.

In an embodiment the descriptor (and results of the geometry processing) are stored in heap memory that is made available to the geometry processing part (and in an embodiment, the tiling/binning stage/circuit of the geometry processing part (i.e. a tiler heap)).

In embodiments, when the geometry processing part generates (and allocates memory (e.g. in the tiler heap) to) a descriptor for a geometry processing pass (as described above), the geometry processing part also allocates memory (e.g. in the tiler heap) for storing the results of the geometry processing pass. (The geometry processing part then can, and in an embodiment does, use that allocated memory to store the results of the geometry processing pass.)

As will be understood, once the fragment processing has performed the render using the results of the geometry processing (pass), those results are no longer required (e.g. for future renders (render passes) that are to be performed for the render output (if any)).

The memory storing the descriptor and results of the geometry processing can therefore be (and in an embodiment is) released (e.g. and in an embodiment by the fragment processing part itself) so that it may be re-used (e.g. to store a new descriptor and geometry processing results for a new geometry processing pass). Releasing the memory in this way back to the geometry processing part therefore provides further memory for the geometry processing part to use, e.g. to store the results of further (incremental) geometry processing passes for the render output in question.

Thus, an embodiment of the technology described herein, the fragment processing releases memory storing the descriptor and the results of the geometry processing after performing the render for the render output being generated.

In embodiments, when the render that is performed is not the final render (to be performed) for the render output (such that, as discussed above, there will be one or more further (incremental) geometry processing passes and render passes to be performed to generate the “finished” (complete) render output), the process of the fragment processing part releasing memory (back to geometry processing part) in an embodiment triggers the geometry processing part to begin a next geometry processing pass (in respect of the render output in question), in an embodiment including generating (and storing) a new descriptor in respect of the next processing pass, allocating memory for storing for the results of the next geometry processing pass (in the manner described above), etc. and so on.

As discussed above, in embodiments of the technology described herein, the geometry processing is triggered to provide the indication to perform a render (e.g. by adding an entry to a FIFO queue) when a shortage of memory (i.e. “an out of memory event”) is encountered during geometry processing. In some embodiments, the geometry processing part is configured to (always) provide the indication to perform a render (e.g. immediately) whenever (i.e. every time) such an out of memory event occurs.

However, in embodiments wherein multiple renders can be queued and/or performed concurrently, it may be the case that an (earlier-scheduled) in-progress or queued render can be completed so that memory is released back to the geometry processing part (as discussed above), thereby resolving the out of memory event and allowing the geometry processing part to resume geometry processing.

The inventors have therefore recognised that it can be beneficial to, rather than immediately triggering the providing of the indication to perform a render when an out of memory event occurs, instead wait until an earlier-queued render is completed (to allow memory to be released back to the geometry processing part) and then resume geometry processing (without triggering the providing of the indication to perform a render at that time). This can reduce the total number of (unnecessary) incremental renders required to generate the render output in question, thereby improving performance.

In an embodiments of the technology described herein, the geometry processing is only triggered to provide an indication to perform a render (when an out of memory event is encountered during geometry processing) when the FIFO queue is empty. In these embodiments, when the FIFO queue is not empty, indicating that an earlier-scheduled render is to be completed, the geometry processing is in an embodiment configured to wait (i.e. stall) until said earlier-scheduled render is completed (and the associated memory is released), at which point the geometry processing part can resume geometry processing.

In an embodiment, when a geometry processing pass is stalled (when an out of memory event is encountered), the hardware resources that were allocated to performing the geometry processing pass can be (and are) reallocated to other (non-stalled) geometry processing passes that are being carried out concurrently by the graphics processor.

In the technology described herein (and as described above), when the fragment processing part performs a render (rendering pass) in response to the indication to perform a render (provided by the geometry processing part), it does so in accordance with the metadata that is associated with the indication to perform the render (provided by the geometry processing part).

As discussed above, the fragment processing part performs rendering/fragment processing operations on the results of the geometry processing (pass) that has been performed. The fragment processing will, and in an embodiment does, generate rendered fragments (e.g. having depth, stencil and/or colour values), which may be, e.g., discarded and/or used to update values in depth and colour buffers, etc. and so on. When rendering for a render output is completed (i.e. all fragment processing for operations required to generate the render output have been completed) in a (final) rendering pass for the render output, the final results (output) of the fragment processing may, e.g., be written to an output buffer (e.g. frame buffer).

As discussed above, however, in the technology described herein, the render (pass) being performed by the render output may not be a final render (pass) to be performed for the render output being generated (but, rather, may be a first or intermediate (i.e. non-final) (incremental) render (pass) in a sequence of (incremental) rendering passes being performed for the render output in question).

In the technology described herein, when such a (non-final) render is performed, rather than, e.g., outputting the results of the (non-final) (incremental) render (pass) as a final output (e.g. to a frame buffer), the results of the (non-final) (incremental) render (pass) are instead stored (by the fragment processing part) as an intermediate output. The fragment processing part can (and in an embodiment does) then, retrieve those results (stored as an intermediate output) and use them when performing a next (incremental) render for the render output.

In an embodiment, this process of storing and retrieving intermediate rendering results is carried out in accordance with the (first and second) metadata (associated with the indication to perform a render) of the technology described herein.

More particularly, in the case wherein the second metadata does not indicate that a render to be performed is a final render for the render output (and this therefore indicates that the render to be performed is a non-final render for the render output), then the fragment processing in an embodiment stores the results of the render as an intermediate output (as discussed above). Similarly (and correspondingly), in the case wherein the first metadata does not indicate that a render to be performed is a first render for the render output (and this therefore indicates that a previous (non-final) render has been performed, and hence an intermediate output stored, for the render output in question), then the fragment processing in an embodiment retrieves the result of the previous render (stored as an intermediate output) and uses them when performing the (present) render for the render output in question.

Thus in an embodiment of the technology described herein, when the (second) metadata (associated with the indication) other than indicates (does not indicate) that a render to be performed (by the fragment processing part) is a final render for the render output being generated, the result of the render by the fragment processing part (i.e. the result of the fragment processing that is performed) is stored as an intermediate output so that it can be used by the fragment processing part when performing a subsequent render for the render output.

Correspondingly, in an embodiment, when the (first) metadata (associated with the indication) other than indicates (does not indicate) that a render that is being performed (by the fragment processing part) is a first render for the render output being generated (such that a previous (incremental) render will have already been performed for the render output, the result of which having been stored as an intermediate output), the fragment processing part, when performing the render, loads the result of the previous (incremental) render that has been stored as an intermediate output (for the render output) and uses it when performing the present render.

Thus, in embodiments of the technology described herein, the metadata (associated with the indication to perform a render provided by the geometry processing part) is used to ensure that fragment processing output data resulting from an incremental render being performed is, in effect, carried forward so it can be used in successive incremental render(s) (for the render output to be generated in question), thereby ensuing continuity so that the entire render process to generate the “full” (complete) render output (across multiple incremental renders) is correctly performed.

Moreover, since the storing and loading of the fragment processing output data can be handled entirely by the fragment processing part of the graphics processor (i.e. hardware), this avoids the need to keep this data updated or maintained for, e.g., software running on the host processor.

The result of an (incremental) render (fragment processing) that is stored as an intermediate output (and later retrieved when performing a subsequent (incremental) render) may comprise any suitable data generated during fragment processing (when performing the render), e.g. colour, stencil and/or depth data (associated with rendered fragments). The results of the (incremental) render (fragment processing) that are stored as an intermediate output could (and in some embodiments) do comprise one or more different type(s) of data compared to the type(s) of data of the results of a final render fragment processing that are stored as a “final” output. For example, the result stored as intermediate output may comprise colour and depth data, whereas the results stored as a final output could comprise colour data only (may not comprise depth data).

When performing a non-final render (for a render output), the fragment processing could store the intermediate output (i.e. non-final incremental rendering results) at a (e.g. selected, e.g. predetermined) location in memory, with the fragment processing then retrieving those results from the same (e.g. selected, e.g. predetermined) location in memory (when performing a subsequent render for the render output).

In some embodiments (as described above), however, wherein (state) information that allows a (non-final) render to be performed (for a render output) is contained in a descriptor for the (non-final) render (which is retrieved and used by the fragment processing part, as described above), this (state) information in an embodiment comprises information indicating where (in memory) the intermediate output should be stored (with the fragment processing part then in an embodiment using this information when performing the (non-final) render to store the intermediate output at the location in memory that the information indicates).

In these embodiments, the descriptor for the next render that is performed (for the render output) in an embodiment comprises (state) information indicating where (in memory) the intermediate output for (i.e. results of) the previous render is stored in memory (with the fragment processing part then in an embodiment using this information when performing the (subsequent) render to retrieve the intermediate output of the previous render from the location in memory that the information indicates).

In these embodiments, although the results of a non-final render (that is performed) are stored (as an intermediate output) in a location indicated by information in the descriptor (as described above), the results of a final render (that are stored as a final output) are in an embodiment stored in a (in an embodiment different) location, e.g. (and in an embodiment) a location that is indicated (for storing the final output of rendering) by the settings of the application running on the host device.

In embodiments (as discussed above), the results of a previous (incremental) render (stored as intermediate output) are retrieved and used by the fragment processing part when performing a subsequent render. The fragment processing part can use the results of the previous (incremental) render (stored as an intermediate output) when performing the subsequent render in any suitable and desired way, in accordance with the rendering (fragment processing) operations that are to be performed.

For example, in an embodiment wherein the results of the previous render that are stored as an intermediate output comprise colour and depth data (associated with rendered fragments), when performing (and in an embodiment, at the start of) the subsequent render (pass) to be performed, this depth and colour data can be (and in an embodiment is) loaded and (in an embodiment) used to populate the depth and colour buffers for the (subsequent render) to be performed. The (subsequent) render can then begin (on the basis of the e.g. depth and colour (buffer) values from the previous (incremental) render that have been loaded from memory.

The above describes the main elements and operation of the graphics processor and graphics processing pipeline that are relevant to operation in the manner of the technology described herein.

As will be appreciated by those skilled in the art, the graphics processor can otherwise include and execute, and in an embodiment does include and execute, any one or one or more, and in an embodiment all, of the processing stages and circuits that graphics processors and graphics processing pipelines may (normally) include.

In an embodiment, the graphics processor comprises, and/or is in communication with, a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus it may comprise, for example, a tile to be generated in a tile based graphics processing system, and/or a frame of output fragment data. The technology described herein can be used for all forms of output that a graphics processor and processing pipeline may be used to generate, such as frames for display, render-to-texture outputs, etc. In an embodiment, the output is an output frame, and in an embodiment an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

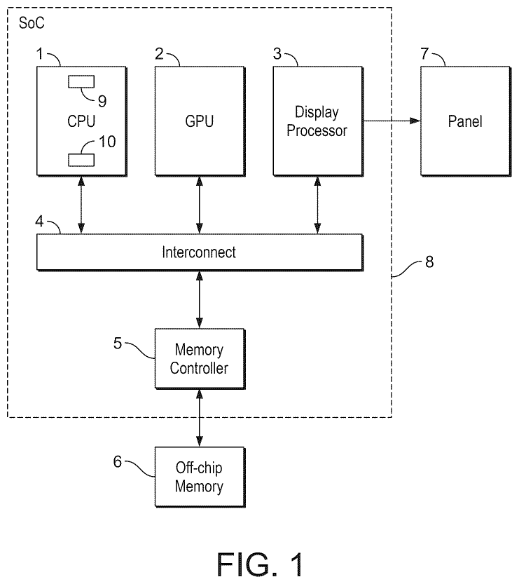

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

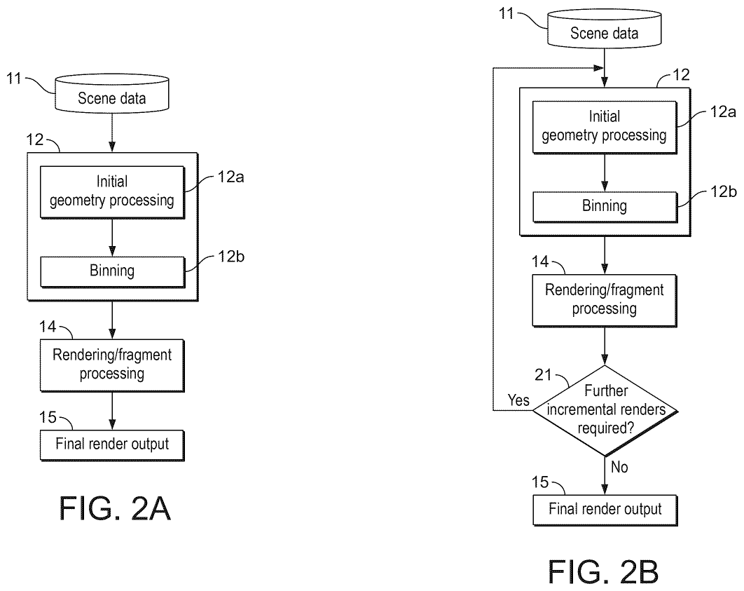

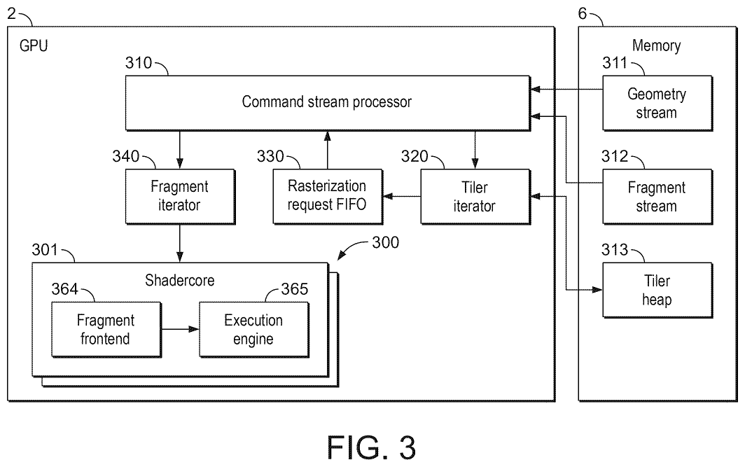

FIGS. 2A and 2B show schematically the processing sequence of the graphics processing pipeline executed by the graphics processor 2 when generating an output in the present embodiments.

FIG. 2A shows a graphics processing pipeline that is executed when a “normal” render is carried to generate a render output, i.e. such that the geometry processing is carried out “in full” (i.e. to completion) in a single pass before a (single) “full” fragment processing pass is carried out.

FIG. 2B shows a graphics processing pipeline wherein multiple “incremental” rendering/fragment processing passes are carried out on the basis of multiple partial geometry processing passes, in order to generate a render output.

FIGS. 2A and 2B show the main elements and pipeline stages. As will be appreciated by those skilled in the art there may be other elements of the graphics processor and processing pipeline that are not illustrated in FIGS. 2A and 2B. It should also be noted here that FIG. 2 is only schematic, and that, for example, in practice the shown pipeline stages may share significant hardware circuits, even though they are shown schematically as separate stages. It will also be appreciated that each of the stages, elements and units, etc., of the processing pipeline as shown in FIGS. 2A and 2B may, unless otherwise indicated, be implemented as desired and will accordingly comprise, e.g., appropriate circuitry, circuits and/or processing logic, etc., for performing the necessary operation and functions.

As shown in FIG. 2A, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12 which comprises an initial geometry processing stage 12a, which performs appropriate geometry processing of and for the scene data to generate the data that will then be required for rendering the output, and a binning/tiling stage 12b (it is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output). This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes (varyings) of vertices (varying shading). It would also be possible for some or all the (non-positional) varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

As shown in FIG. 2A, the processed geometry (resulting from (initial) geometry processing stages 12a) is subjected to binning by a binning/tiling stage 12b. The geometry processing stage 12a and binning stage 12b in an embodiment operate concurrently (in a pipeline) (rather than, e.g., geometry processing stage 12a processing all of the geometry before it is subjected to binning in the binning stage 12b).

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 12b may also cull primitives that are not visible (e.g. that fall outside the view frustum, and/or based on the facing direction of the primitives).

As part of the (initial) geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the (initial) geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

In the “normal” rendering process shown in FIG. 2A, the geometry processing (including initial geometry processes and the tiling/billing process) is carried out to completion (i.e. for all of the primitives for the render output being generated), to generate all of the necessary (binned) intermediate geometry data and data structures for identifying primitives to be processed for respective tiles of the render output, in a single pass.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 12b to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise render data intended for use in later rendering passes (also known as a “render to texture” output), or for deferred rendering, or for hybrid ray tracing, etc.

The graphics processing pipeline shown FIG. 2B comprises a geometry processing stage 12 (comprising initial geometry processing stage 12a and binning/tiling stage 12b) and a rendering/fragment processing stage 14, similarly to FIG. 2A.

In FIG. 2B, however, a sequence of “incremental” renders is performed to generate the full (“complete”) render output 15. Geometry processing is carried out by geometry processing stage 12 across plural “partial” geometry processing passes, each of which is followed by a respective incremental render (rendering pass) performed by rendering/fragment processing stage 14.

Thus, in a geometry processing pass that is performed, geometry processing stage 12 subjects a subset (but not all) of the geometry (primitives) to geometry processing (including initial geometry processing by initial geometry processing stage 12a and tiling/binning by tiling/binning stage 12b, as discussed above) to generate intermediate geometry data and data structures for identifying primitives to be processed for respective tiles of the render output (as discussed above), which are then used by rendering fragment processing stage 14 to perform an “incremental” render.

When further incremental renders are required (to generate the full “complete” render output) at step 21, then the geometry processing stage 12 performs another (“partial”) geometry processing pass, the results of which are then subjected to a further incremental render by rendering/fragment processing stage 14, etc. and so on. This process is repeated until the final “complete” render output 15 is generated across the plural incremental renders that are performed.

Incremental rendering, as shown in FIG. 2B, may be triggered when “normal” tile graphics processing (as shown in FIG. 2A) is not possible. For example, incremental rendering may be triggered if the geometry processing stage 12 runs out of memory to store the intermediate geometry generated, at which point the geometry processing pass being performed is terminated and an (incremental) rendering pass is triggered to be performed by rendering/fragment processing stage 14.

Once the incremental render is performed, the intermediate geometry data generated during the first geometry processing pass by geometry processing stage 12 is no longer required and can therefore be discarded (by rending/fragment processing stage 13), thereby releasing memory for the geometry processing stage 12 to continue with geometry processing in another “partial” geometry processing pass (either until geometry processing is completed for the render output being generated or until another out of memory event is encountered, etc., and so on).

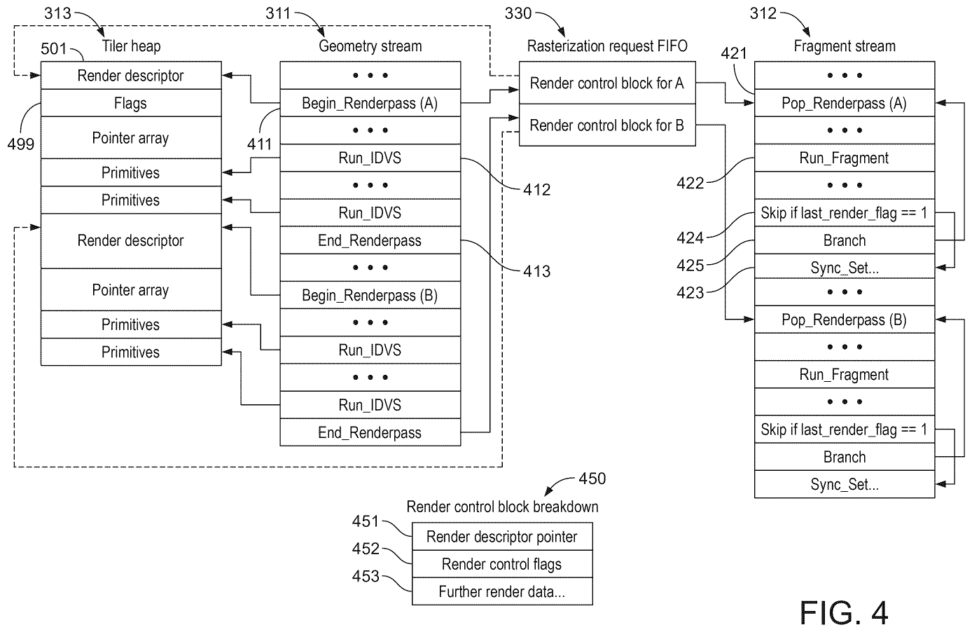

FIG. 3 shows an embodiment of a graphics processor (GPU) 2 that can execute a graphics processing pipeline of the form shown in FIG. 2, and that can be operated in the manner of the technology described herein.

FIG. 3 shows the main elements of the graphics processor (GPU) 2 that are relevant to the operation of the present embodiments. As will be appreciated by those skilled in the art, there may be other elements of the graphics processor that are not illustrated in FIG. 3. It should also be noted that FIG. 3 is only schematic, and that, for example, in practice the shown functional units and pipeline stages may share significant hardware circuits, even though they are shown schematically as separate stages in FIG. 3.

As shown in FIG. 3, the tile-based graphics processor 2 includes a command stream processor 310, a tiler iterator 320, a rasterization request FIFO queue 330, a fragment iterator 340 and a set of shader cores 300. FIG. 3 shows two shader cores, but other numbers of shader cores are possible. FIG. 3 shows schematically the relevant configuration of one shader core 301, but as will be appreciated by those skilled in the art, further shader cores of the graphics processor 2 can be configured in a corresponding manner (although there may also be some differences between different shader cores of the graphics processor).

The GPU 2 is in communication with off-chip memory 6. A geometry (command) stream 311 and fragment (command) stream 312, both of which have been built up by the host processor 1, may be stored in the memory 6. The geometry stream 311 comprises instructions which (when executed) cause the GPU to carry out geometry processing. The fragment stream 312 comprises instructions which (when executed) cause the GPU to carry out fragment processing.

The geometry stream 311 and fragment stream 312 are executed (in parallel) by the command stream processor 310. The command stream processor 310 distributes subtasks to the tiler iterator 320 (during and in response to execution of the geometry stream 311) and fragment iterator 340 (during and in response to execution of the fragment stream 312), appropriately.

The graphics processor 2 of FIG. 3 is a tile-based graphics processor. In a tile-based rendering system the render output (e.g. frame for display) is divided into a plurality of tiles for rendering. Typically, each tile is 16×16, 32×32, or 64×64 data elements (sampling positions) in size, with the render output being divided into however many such tiles as are required for the render output size and shape that is being used. The tiles are rendered separately to generate the render output.

To do this, the command stream processor 310 executes a geometry stream 311 to perform geometry processing (i.e. a geometry processing pass). To perform geometry processing, geometry processing tasks are described to (and then executed by) the shader cores 300.

The geometry processing includes performing vertex processing tasks (i.e. “vertex shading”), which may include, for example, transforming vertex position attributes from the model space that they are initially defined for to the screen space that the output of the graphics processing is to be displayed in. The results of the vertex shading, i.e. shaded vertex position data, and any shaded non-positional vertex data, are stored in tiler heap memory 313.

The geometry processing also includes a tiling/binning process that is executed by the tiler iterator 320, wherein the shaded vertex position data is used to generate data structures, such as primitive lists and/or hierarchies of bounding boxes, to determine which primitives need to be processed for respective tiles or set of tiles.

As will be discussed below, when all of the primitives for the render output being generated have been processed (i.e. geometry processing is “complete”), or (before all of the primitives have been processed) when there is determined to be a lack of memory available (i.e. an “out of memory event” is encountered) for storing the results of the geometry processing, the tiler iterator 320 is triggered to send an indication to cause the fragment processing to perform a render.

To send the indication to perform the render (and as discussed above), the tiler iterator 320 adds an entry relating to the render (i.e. render pass) to be performed to the rasterization request FIFO queue 330. Fragment processing (i.e. the command stream processor 310, executing the fragment stream 312), periodically checks rasterization request FIFO queue 330 and retrieves the entry (i.e. the indication to perform a render) when able to do so. This triggers the fragment processing to carry out the render pass in accordance with the indication.

As will be discussed further below, the indication to perform a render (that the tiler iterator 320 adds to the queue of rasterization FIFO 330) includes metadata that is set according to whether the render to be performed is a first render to be performed for the render output that is being generated, and metadata that can be set to indicate that the render to be performed is a final render to be performed for the render output that is being generated. The metadata comprises a first flag (“first_render_flag”) which is set to TRUE if the render to be performed is a first render for the render output being generated (and false otherwise) and a second flag (“last_render_flag”) which is set to TRUE if the render be performed is a last render (and false otherwise).

Once the entry stored in the FIFO 330 is retrieved by the fragment stream, this causes the fragment processing stream to begin performing a render (i.e. rendering tiles of the render output to be generated).

To do this (and as will be discussed further below) the command stream processor 310, executing the fragment stream 312, configures fragment processing in accordance with the metadata, so that the render can be performed accordingly.

To perform a render (fragment processing), the fragment iterator 340 distributes fragment processing tasks to the fragment frontend 364 of the shader core(s) 300. Execution threads are then issued to execution engine(s) 365 for processing fragments.

The execution engine 365 is operable to execute fragment shader programs for execution threads to perform fragment processing operations. In order to perform fragment processing operations, the programmable execution engine (unit) 365 will execute fragment shader programs (sequences of instructions) for respective execution threads (e.g. corresponding to respective (sets of) sampling positions of an output to be rendered).

As will be discussed further below, output data generated by the execution engine 365 performing fragment processing operations is either stored as an intermediate render output (if the render being performed is not a final render for the render output being generated), such that it can be retrieved when performing a subsequent render (for the render output), or as a final render output (when the render is the final render for the render output being generated) in accordance with how the render is configured based on the metadata.

When the final render for a render output is being performed, once final render output data for a tile has been generated it is exported from the tile buffer to the main memory 6 (e.g. to a frame buffer in the main memory 6) for storage, and the next tile is then processed, and so on, until all the tiles to generate the entire render output (e.g. frame (image) to be displayed) have been processed. The next render output (e.g. frame) may then be generated, and so on.

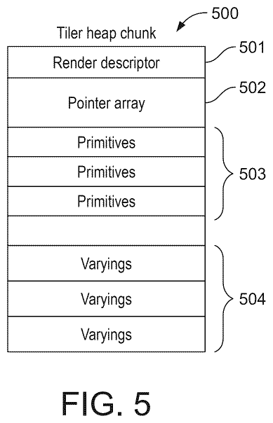

FIG. 4 shows an overview of the corresponding data structures used/generated when performing graphics processing operations an embodiment of the technology described herein.

Thus, FIG. 4 shows an exemplary geometry stream 311 (which, when executed, causes geometry processing to be carried out for render outputs to be generated), an exemplary fragment stream 312 (which, when executed, causes fragment processing to be carried out for render outputs to be generated), the contents of rasterization request FIFO queue 330, and tiler heap 402. As discussed above, the geometry stream 311 and fragment stream 312 are executed by the command stream processor 310 in parallel.

In these examples, the geometry stream 311 and fragment stream 312 both include (and will cause to be generated) two render outputs, “RENDERPASS (A)” and “RENDERPASSS (B)”. The overall “renderpass” that is being performed thus refers to and comprises both geometry processing (caused by execution of the geometry stream 311) and fragment processing (caused by execution of the fragment stream 312) for the render output being generated.

The geometry stream 311 includes a BEGIN_RENDERPASS instruction 411, which, when executed, causes a request to be sent to the tiler iterator 320 to start a (new) render pass (render output). In response to this, the tiler iterator 320 sets up render control flags (metadata) 499 (in the tiler heap 313): a first_render_flag that can be set to indicate that a render to (later) be performed (by fragment processing) is a first render for the render output (renderpass) being generated, and a last_render_flag that can be set to indicate that a render to be performed is a final render to be performed for the render output (renderpass) being generated.

To start the new render pass, the tiler iterator 320 allocates storage from the tiler heap 313 to, and generates a new render descriptor 501, for the render pass. The tiler iterator 320 also allocates storage in the tiler heap 313 for storing the results of geometry processing of the render pass, i.e. primitives (primitive vertex indices) 503, shaded geometry data (varyings) 504, and pointer array 502 (which points to respective data structures (e.g. tile lists) in memory which can identify which primitives need to be processed for respective rendering tiles).

The render descriptor 501 that is generated by the tiler iterator 320 contains various attributes (state information) which indicate how the fragment processing pass (i.e. render) is to be performed (by the fragment processing). The attributes that are contained in the descriptor include one or more of: the size of the render output, the size of the tiles, colour depth etc., and so on.

(In the present embodiment, when generating the render descriptor 501, the tiler iterator 320 determines the attributes for the render descriptor 501 based on (e.g. by copying) the attributes of an earlier-generated descriptor (not shown) that has already been generated by the driver for the graphics processor executing on the host processor.)

Execution of the BEGIN RENDERPASS instruction 411 also causes the tiler descriptor to set the first_render_flag 499 (in tiler heap 313) to TRUE. (As a new render pass is being started for the render output to be generated, this means that the next render to be performed for the render output by fragment processing will necessarily be the first render for the render output.)

Once the BEGIN_RENDERPASS instruction 411 has been executed (and the render descriptor, pointer array, etc. has been set up, as discussed above), the command stream processor 310 proceeds to execute one or more RUN_IDVS instructions 412 (of the geometry processing stream) as part of the geometry processing pass being performed.

The RUN_IDVS instruction 412, when executed, causes geometry processing to be carried out in respect of the primitives for the render output to be generated, including vertex shading, etc. (as described above). Primitives (primitive vertex indices) 503 and shaded primitive vertex data (varyings) 504 are stored in their allocated storage in tiler heap 513. A binning process is also executed by the tiler iterator 320, wherein primitives are added to appropriate binning data structures (e.g. tile lists generated by the binning process) and pointers (to those binning data structures) in the pointer array 502 are updated accordingly (in accordance with the location(s) of the binning data structures generated for the render output).

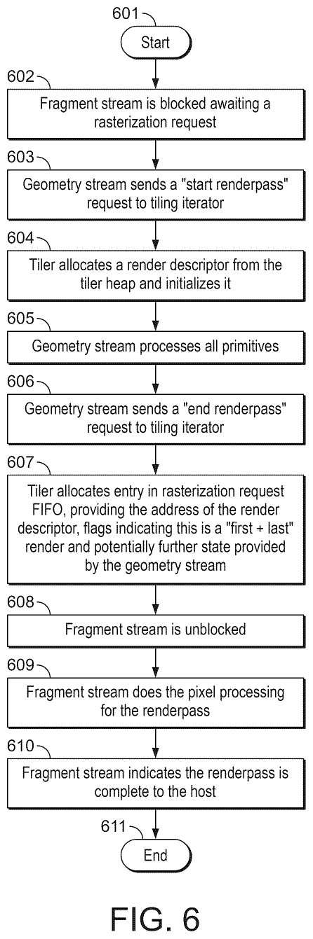

An example portion (chunk) 500 of tiler heap 313, containing the results of geometry processing that is executed as a geometry processing pass of a render pass, is shown in FIG. 5. The chunk 500 includes render descriptor 501, along with geometry processing results, i.e. pointer array 502, primitives 503 (primitive vertex indices), and shaded geometry data (varyings) 504. In the present embodiment, these geometry processing results are stored in predetermined (memory) locations in the portion (chunk) 500 relative to the (memory) location of the render descriptor 501 (which, as discussed further below, allows fragment processing to later use a pointer to the descriptor 501 to locate and retrieve the geometry processing results.)

Once all RUN_IDVS instructions 412 have been executed, such that all primitives for the render output being generated will have been processed (i.e. geometry processing for the render pass is complete), a final END_RENDERPASS instruction 413 (of the geometry stream 311) is executed.

When executed, the END_RENDERPASS instruction 413, causes a request to be sent to the tiler iterator 320 to end the (geometry processing for the) render pass (by triggering a (fragment processing) render). This causes the tiler iterator 320 to set the last_render_flag to TRUE, and then send an indication (to fragment processing) to perform a render by adding an entry in the rasterization request FIFO queue 330 (if there is space available in the rasterization request FIFO queue 330 to do so). (The tiler iterator sets the last_render_flag to TRUE since all primitives for the render output have been processed (in the geometry processing pass), and hence (as will be understood) this means that the render to be performed (by fragment processing) will necessarily be the final render for the render output in question.)

The tiler iterator 320 may also be triggered to send an indication to perform a render (by adding an entry to the rasterization request FIFO queue 330) during (or between) execution of the RUN_IDVS instruction(s) (i.e. during the execution of a geometry processing pass for a render pass before the geometry processing for a render pass is complete), if an “out of memory event” occurs, i.e. there a lack of memory available for storing results of geometry processing in the tiler heap chunk 500. In this case, however, if such an out of memory event occurs, the tiler iterator 320 sets the last_render_flag to FALSE (since, as will be understood, with geometry processing not yet complete, this means that the render to be performed will necessarily not be the final render for the render output (and at least one subsequent render will be required)).

The indication to perform the render (i.e. the entry that the tiler iterator 320 adds to rasterization request FIFO queue 320) includes, as shown in more detail in the render control block breakdown 450, a pointer 451 to the render descriptor 501, and the two render control flags 452 (metadata): the first_render_flag that is set (by the tiler iterator 320) to TRUE when the render to be performed is a first render to be performed for the render output being generated (i.e. when the BEGIN_RENDERPASS instruction 411 is executed, as discussed above), and the last_render_flag that is set (by the tiler iterator 320) TRUE when the render to be performed is a last render to be performed for the render output being generated (i.e. when the END_RENDERPASS instruction 413 is executed, as discussed above).

The indication to perform also includes further render data 453 which includes state information relating to how the render is to be performed (which can later be used by fragment processing to configure the render to be performed).

(The rasterization request FIFO queue 330 has space to store only a limited amount of entries. If the rasterization request FIFO 330 is already full when the tiler iterator 320 attempts to add the entry (such that it is not possible for another entry to be added), the tiler iterator 320 continues periodically attempting to add the entry to the rasterization request FIFO queue 330, until able (i.e. there is space available) to do so.)

(In the case wherein the tiler iterator 320 is triggered to send an indication to perform an (incremental) render due to an “out of memory” event (as discussed above), once the entry has been added to rasterization request FIFO queue 330, the tiler iterator is triggered to immediately attempt to generate (and store in the tiler heap 313) a further render descriptor in respect of the next (incremental) render to be performed. However, since memory is required to do this (which is not immediately available), the tiler iterator will not be able to complete this step until further memory is released by fragment processing (as discussed further below).)

The fragment stream 312 includes a POP_RENDERPASS instruction 421, which, when executed, causes the command stream processor 310 to (attempt to) read an entry (i.e. an indication to perform a render) from the Rasterisation Request FIFO 330.

As discussed, above, the geometry stream 411 and fragment stream 312 are executed by the command stream processor 310 in parallel. This means that when the POP_RENDERPASS instruction 421 in the fragment stream 312 is executed, the Rasterisation Request FIFO 401 may be empty (since the tiler iterator 320 may not yet have added an entry (i.e. indication to perform a render) to the rasterization request FIFO queue 330). In this case, fragment processing will stall when the POP_RENDERPASS instruction 421 is executed, since there is nothing to be retrieved from the Rasterisation Request FIFO 401. During this stalling, periodic attempts are made to read an entry from the Rasterisation Request FIFO queue 330 until able to do so (i.e. until an entry has been added).

The (successful) reading of the entry from the rasterization request FIFO queue 330 (when the POP_RENDERPASS instruction 421 is executed) in effect means that the indication to perform a render is “received” by the fragment processing. Once the entry in the FIFO queue 330 has been read, the (memory storing the) entry in the rasterization FIFO queue 330 can be released (thereby creating space in the rasterization queue 330 for further entries to be added by the tiler iterator 320, as described above).

After the entry has been read (i.e. the indication to perform a render has been received), fragment processing is then configured in accordance with the contents of the entry. The fragment iterator 340 uses the render descriptor pointer 451 to locate and read the render descriptor 501 (and attributes associated therewith) stored in tiler heap 513, and fragment processing is configured in accordance with the attributes of the descriptor 501, and in accordance with the further render data 453.

Fragment processing is further configured in accordance with the render control flags first_render_flag and last_render_flag.

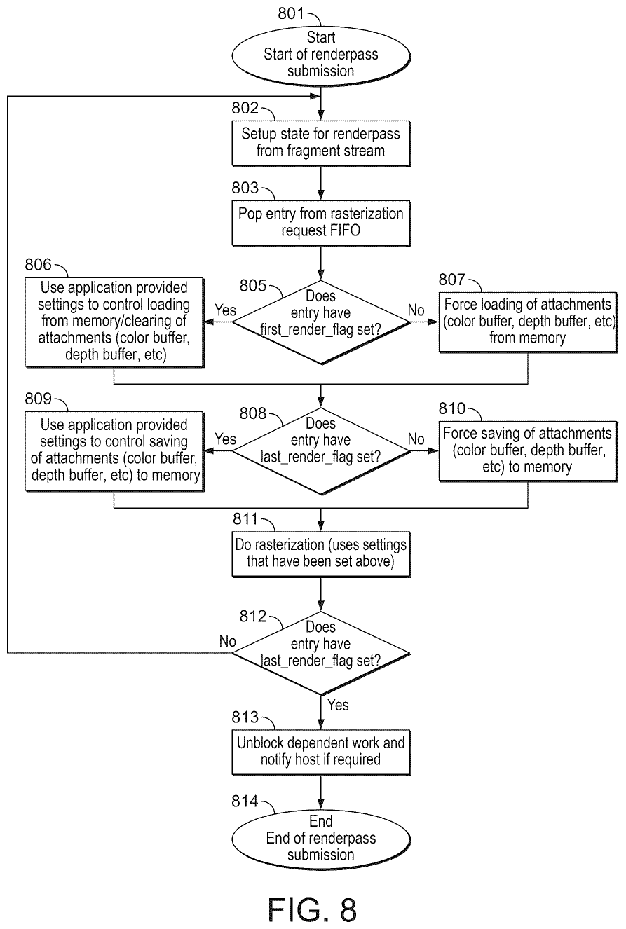

(As will be discussed further below in relation to FIG. 8, if the last_render_flag is set to FALSE (indicating that the present render to be performed is a non-final incremental render for the render output being generated, and hence that one or more further (subsequent) renders will be performed for the render output), then fragment processing is configured such that the results of the render that is to be performed are stored as an intermediate output (so they can be retrieved and used in a further (subsequent) (incremental) render that is performed). If the first_render_flag is set to FALSE (indicating that one or more (incremental) renders have already been performed for the render output, previous to the present (incremental) render to be performed), then this means that the results of a previous render will have been stored as an (intermediate) output, and thus fragment processing is configured such that those intermediate results are retrieved and used when performing the render.)

A RUN_FRAGMENT instruction 422 in the fragment stream 312 is then executed, thereby causing fragment processing operations (i.e. a render) to be performed (by shader cores 300, as discussed above), in accordance with how the render is configured based on the metadata.

The result of the geometry processing (pass), i.e. the pointer array 502, primitives 503 and varyings 504, are read from the tiler heap 313 and used when performing the fragment processing operations. (In the present embodiment, the results of the geometry processing are stored in predetermined position in memory (in the tiler heap) relative to the location in memory of the descriptor 501. Thus, by using the render pointer descriptor 451 to locate the render descriptor 501, the various results of geometry processing can also be located (and retrieved), as required. Other arrangements would, of course, be possible.)

After fragment processing (i.e. a render) has been performed (in respect of the results of the geometry processing pass), then the memory (i.e. tiler heap chunk 500) storing the descriptor 501 and results of geometry processing pass are released, so that they can be re-used by tiler iterator 320 and geometry processing (when performing another geometry processing pass).

The results of the fragment processing (render) are stored in memory 6 in accordance with the indicated “render” configuration. In the case where the last_render_flag is set to FALSE, the results are stored as an intermediate output (such that they can be retrieved and used in a further (subsequent) render). In the case where the last_render_flag is set to TRUE, meaning that the results of the render correspond to the full “complete” render output, this full “complete” render output is stored as final output.

Once the render (i.e. fragment processing pass) is completed, it is determined whether the last_render_flag is set to TRUE or FALSE.

When the last_render_flag is set to FALSE, meaning that the results of the render have been stored as an “intermediate output” and at least one further geometry processing pass (and hence at least one further render) will need to be carried out for the render output being generated, then BRANCH 425 causes the POP_RENDERPASS instruction 411 to be executed once again, thereby causing the command stream processor 310 to (attempt to) read a further entry (i.e. a indication to perform a (next) render (for the render output being generated), from the Rasterisation Request FIFO 330, etc. and so on (and as described above).

(In the case where a next another (incremental) geometry processing pass is to be performed, and (as discussed above) the tiler iterator 320 is attempting to generate a further render descriptor, the completion of the present render by the fragment processing and release of the memory (as discussed above) allows the tiler iterator to set the first_render_flag to FALSE (to indicate that any further renders that are to be carried out will not be the first render for the render output being generated) and to (successfully) generate and store in tiler heap 313 a new render descriptor 501 in respect of the next (incremental) geometry processing pass, allocate storage for storing the results of the (incremental) geometry processing pass, etc. and so on (as described above).)

When the last_render_flag is set to TRUE (i.e. a value of 1), meaning that all rendering for the render output is completed (i.e. the full “complete” render output has been generated and stored as a final output), SKIP 424 causes BRANCH 425 to be skipped so that the final instruction of the fragment stream, i.e. SYNC_SET instruction 423, is executed. Execution of the SYNC_SET instruction 423 causes a notification to be sent to the host that rendering is completed.

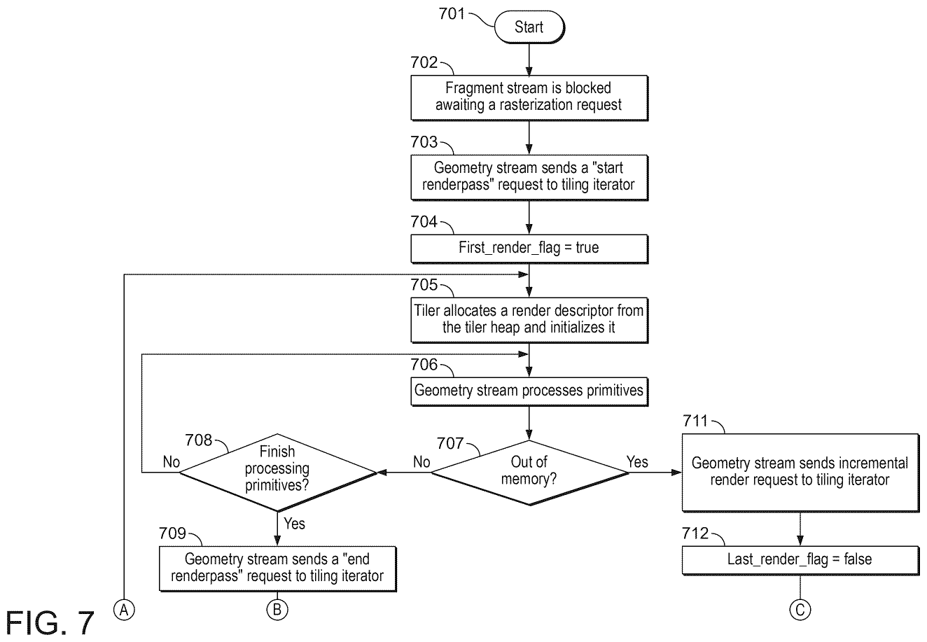

FIG. 6 is a flowchart of the operation of the graphics processor according to the present embodiment in the case where a normal “full” render is carried out for the render output being generated, i.e. such that the geometry processing is carried out “in full” (i.e. to completion) (such that all of the primitives for the render output are processed in a single geometry processing pass) before a “full” fragment processing pass is carried out (using the results of the “full” geometry processing pass), to generate the (full) render output.

The processes shown in FIG. 6 are caused to be carried out by execution of instructions of the geometry stream 311 and fragment processing stream 312 by the command stream processor 310, and are performed by, e.g., the fragment iterator 340 and the tiler iterator 320 (by issuing tasks to shader core(s) 300, etc.), as described above.

In step 601, the geometry and fragment streams begin execution. However, and as discussed above, since the rasterization request FIFO queue 330 is empty, fragment processing stalls (i.e. is “blocked”) when the POP_RENDERPASS instruction 421 in the fragment stream 312 is executed (since the attempt to read an entry from the rasterization request FIFO queue 330 will fail) (step 602).

In step 603, the BEGIN_RENDERPASS instruction 411 in the geometry stream is executed, which causes a request to be sent to the tiler iterator 320 to start a (new) render pass in respect of the render output that is to be generated. The tiler iterator 320 sets up render control flags (metadata) 499 (first_render_flag and last_render_flag) in the tiler heap 313. As a first geometry processing pass is to be performed for the render output to be generated (and hence the next render to be performed by the fragment processing will also be the first render (pass) to be performed for the render output in question), the tiler iterator 320 sets the first_render_flag to TRUE.

To start the new render pass, as discussed above, the tiler iterator 320 generates a new render descriptor 501 and allocates storage for it in the tiler heap 313 (step 604), as well as also allocating storage for pointer array 502, primitives 503 and varyings 504 (in portion (chunk) 500).

In step 604, one or more RUN_IDVS instruction(s) 412 (in the geometry stream) are executed, causing geometry processing (i.e. a geometry processing pass) to be carried out in respect of all the primitives for the render output being generated, as discussed above. The results of the geometry processing (i.e. primitives 503, shaded geometry data (varyings) 504 and the pointer array 502) are stored in the allocated tiler heap portion (chunk) 500.

Once geometry processing has been completed for the render output to be generated, the END_RENDERPASS instruction 413 is executed, which causes a request to be sent to tiler iterator 320 to end the render pass (step 606). This triggers the tiler iterator 320 (in step 607) to set the last_render_flag to TRUE (since all of the primitives for the render output have been processed, and hence the render to be performed by fragment processing will necessarily be the final render for the render output), and then send an indication that a render is to be performed (to fragment processing) by adding an entry in the FIFO (as discussed above). The entry includes a pointer 451 to the render descriptor 501, and the two render control flags 452 (metadata): first_render_flag and last_render_flag.

(In this case, since only a single geometry processing pass is performed (and hence only a single render (pass) is to be performed, i.e. the render to be performed is both the “first” and the “last” for the render output being generated), both the first_render_flag and last_render_flag have been set by the tiler iterator 320 to TRUE (as discussed above).)

Now that the entry has been added to the rasterization request FIFO queue 330, the fragment processing can successfully read the entry (thereby causing fragment processing to be “unblocked”, step 608) and thereby receive the indication to perform a render. The render descriptor pointer 451 is used to locate the render descriptor 501, and fragment processing is configured in accordance with the attributes of the descriptor 501 and the render control flags 452 (which have both been set to TRUE, see above).

(In this case, and as will be discussed further in relation to FIG. 8 below, since the first_render_flag is set to TRUE, the render is configured to use (default) application-provided settings to control the loading from memory and clearing of the required data structures (attachments) (colour buffer, depth buffer etc.) in the render to be performed. Since the last_render_flag is also set to TRUE, the render is further configured to use (default) application-provided settings to control the saving of the results of the present render (attachments) to memory, meaning that the result of the render that is generated will correspond to the full (“complete”) render output, which is to be stored as a final output.)

The render is performed (i.e. the RUN_FRAGMENT instruction 422 in the fragment stream is executed) in accordance with the render settings determined based on the render control flags (step 609), and the full (“complete”) render output is generated.

Once the rendering has been completed (i.e. the full (complete) render output has been generated and stored as a “final output”), and since the last_render_flag is set to TRUE (and hence the final “complete” render output has been generated), the SYNC_SET instruction 423 in the fragment stream is executed, thereby causing the host to be notified that rendering is completed (step 610).

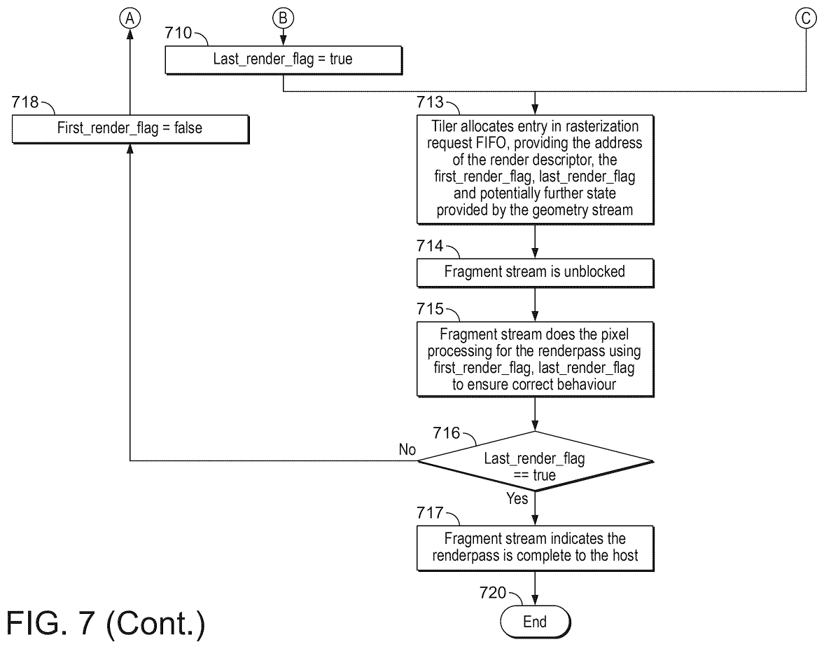

FIG. 7 shows a (more detailed) flow chart of the operation of the graphics processor according to the present embodiment, in the case when an “out of memory” event occurs during geometry processing. This causes rendering to be carried out incrementally, i.e. with a sequence of incremental renders being carried out using the results of a corresponding sequence of (partial) geometry processing passes.

The processes shown in FIG. 7 are caused to be carried out by execution of instructions of the geometry stream 311 and fragment processing stream 312 by the command stream processor 310, and are performed by, e.g., fragment iterator 340 and the tiler iterator 320 (by issuing tasks to shader cores 300, etc.), as described above

Steps 701, 702 and 703 in FIG. 7 correspond directly to steps 601, 602 and 603 (respectively) in FIG. 6, discussed above.

The geometry and fragment streams begin execution (step 701), However, and as discussed above, since the rasterization request FIFO queue 330 is empty, fragment processing stalls (i.e. is “blocked”) when the POP_RENDERPASS instruction 421 in the fragment stream 312 is executed (since the attempt to read an entry from the rasterization request FIFO queue 330 will fail) (step 702).

In step 703, the geometry stream sends a request to the tiler 320 to begin a new render pass for the render output to be generated (step 703). The tiler iterator 320 sets up render control flags (metadata) 499 (first_render_flag and last_render_flag) in the tiler heap 313. As a first geometry processing pass is to be performed for the render output in question (and hence that the next render that is performed by the fragment stream will also be the first render to be performed for the render output in question), the tiler iterator sets the first_render_flag to TRUE (step 704).

To start the new render pass, as discussed above, the tiler iterator 320 generates a new render descriptor 501 and allocates storage for it in the tiler heap 313 (step 705), as well as also allocating storage for pointer array 502, primitives 503 and varyings 504 (in portion (chunk) 500).

In step 706, one or more RUN_IDVS instruction(s) 412 (in the geometry stream) are executed, causing geometry processing (i.e. a geometry processing pass) in respect of primitives for the render output that is being generated. It is periodically determined whether or not there is a lack of memory available (in portion (chunk) 500 of tiler heap 313) for storing the results of (further) geometry processing (step 707). If there is not a lack of memory available, and there are further primitives to be processed (step 708), then geometry processing can proceed and further primitives are processed (step 706).

If, however, it is determined that there is a lack of memory available for storing the results of (further) geometry processing, then this triggers the sending of request to the tiler iterator 320 to end the geometry processing (pass) at this point so that a render can be performed (step 711). Since geometry processing for the render output in question has not been carried out to completion (due to the running out of memory for storing geometry processing results), the last_render_flag is set by the tiler iterator 320 to FALSE (step 712).

The tiler iterator 320 then proceeds to send an indication (to the fragment stream) that a render is to be performed (step 713), by adding an entry to the rasterization request FIFO 330 containing pointer 451 to the render descriptor 501, and two render control flags 452 (metadata) first_render_flag and last_render_flag (as described above). (As will be understood, in the case wherein, e.g., the indication to perform a render is triggered as a result of the first geometry processing pass for the render output encountering a lack of memory, the first_render_flag will have been set to TRUE and the last_render_flag will have been set to FALSE (as described above).)

(In the case wherein the indication to perform a (incremental) render is triggered (as a result of a lack of memory) (and hence there will be at least further incremental render to be performed for the render output being generator), the tiler iterator 320 is triggered to immediately attempt to generate (and store in tiler heap 313) a further render descriptor in respect of the next (incremental) geometry processing pass to be performed. However, since memory is required to do this (which is not immediately available), the tiler iterator will not be able to complete this step until memory is released by fragment processing (as discussed further below).)

Now that the entry has been added to the rasterization request FIFO queue 330, the fragment processing can successfully read the entry (thereby causing fragment processing to be “unblocked”, step 714) and thereby receives the indication to perform a render. The render descriptor pointer 451 is used to locate the render descriptor 501, and fragment processing is configured in accordance with the attributes of the descriptor 501 and the render control flags 452.

(As will be discussed further below in relation to FIG. 8, in the case wherein, e.g., the (incremental) render to be performed is triggered as a result of the first geometry processing pass for the render output encountering a lack of memory, since the first_render_flag is set to TRUE, the render is configured to use (default) application-provided settings to control the loading from memory and clearing of the required data structures (attachments) (colour buffer, depth buffer etc.) in the render to be performed. Since the last_render_flag is set to FALSE, the render is configured to force saving of the results of the render (attachments) to memory as an intermediate output (so that it can be loaded in the next render to be performed)).

The render is then performed (i.e. the RUN_FRAGMENT instruction 422 in the fragment stream is executed) (step 715) in accordance with the render settings determined based on the render control flags. Once the render is completed and the results stored to memory (as either an intermediate output or final output, depending on the configured render settings), the memory (in tiler heap portion (chunk) 500) storing the descriptor 501 and results of the geometry processing pass (i.e. pointer array 502, primitives 503 and varyings 504) is released (so that it can be re-used to store a new render descriptor and results of a further geometry processing pass).

Fragment processing then determines whether the last_render_flag is set to TRUE (step 716).

If the last_render_flag is set to TRUE, meaning that the full (complete) render output has been generated and stored as a “final output” (and hence no further renders (rendering passes) are to be performed for the render output), then the SYNC_SET instruction 423 in the fragment stream 312 is executed, thereby causing the host to be notified that rendering is completed (step 717).

If the last_render_flag is determined to be set to FALSE at step 716, meaning that the render performed by the fragment processing stage was not the final render to be performed for the render output being generated (and that the results of the render have been stored as an “intermediate output), then this indicates that further geometry processing (i.e. another (incremental) geometry processing pass) is to be performed for the render output. In this case, fragment processing executes the POP_RENDERPASS instruction 421 once again, and thereby attempts to read a further entry (i.e. an indication to perform a (next) render (for the render output being generated), from the Rasterisation Request FIFO 330.

In this case, wherein another (incremental) geometry processing pass is to be performed, and (as discussed above) the tiler iterator 320 is attempting to generate a further render descriptor, the completion of the present render by the fragment processing and release of the memory (as discussed above) allows the tiler iterator to set the first_render_flag to FALSE (step 718) (to indicate that any further renders that are to be carried out will not be the first render for the render output being generated) and to successfully generate (and store in tiler heap 313) a new render descriptor 501 (step 705) in respect of the next (incremental) geometry processing pass, allocate storage for storing the results of the (incremental) geometry processing pass, etc. and so on (as described above).

The geometry processing pass then progresses (by processing further primitives for the render output being generated) (step 706), either until (i) another out of memory event occurs (“Yes” in step 707), at which point the (incremental) geometry processing pass is ended to trigger another (incremental) render to be performed (as described above), or until (ii) all the primitives have been processed for the render output that is being generated (“Yes” in step 708) (such that geometry processing for the render output is “completed”).

If all primitives have been processed for the render output (i.e. geometry processing has been carried out to completion for the render output), a request is sent to tiler iterator 320 to end the geometry processing pass (step 709). Since all of the primitives have been processed (and geometry processing is now complete), it can be concluded that the next render to be performed will be the final render to be performed for the render output being generated, and hence the tiler iterator sets the last_render_flag to TRUE (step 710).

The tiler iterator 320 then proceeds to send an indication (to the fragment stream) that a render is to be performed (step 713), by adding an entry to the rasterization request FIFO 330 containing pointer 451 to the render descriptor 501, and two render control flags 452 (metadata) first_render_flag and last_render_flag (as described above). (As will be understood, in the case wherein the indication to perform a render is triggered by a geometry processing pass that is not the first geometry processing pass for the render output but is the final geometry processing pass (since all primitives have been processed), the first_render_flag will have been set to FALSE and the last_render_flag will have been set to TRUE).

Now that the entry has been added to the rasterization request FIFO queue 330, the fragment processing can successfully read the entry (thereby causing fragment processing to be “unblocked”, step 714) and thereby receive the indication to perform a render. The render descriptor pointer 451 is used to locate the render descriptor 501, and fragment processing is configured in accordance with the attributes of the descriptor 501 and the render control flags 452.

(In the case wherein the (incremental) render to be performed is not the first render for the render output in question, and hence the first_render_flag is set to FALSE (as discussed above), this means that the results of the previous render will have been stored as an intermediate output, and so fragment processing is configured to force the loading of this intermediate output to be used the render to be performed.)

Fragment processing proceeds to perform the render (as described above) (step 715), in accordance with the render settings determined based on the render control flags.

Fragment processing then determines once again whether the last_render_flag is set to TRUE (step 716).

If the last_render_flag is set to TRUE (“Yes” in step 716) then the SYNC_SET instruction 423 is executed. This means that the full (complete) render output has been generated and stored (as a “final output”), and the host is notified that rendering is completed (step 717).

FIG. 8 shows in more detail the fragment processing pipeline that is carried out when executing the fragment stream 312 in embodiments of the technology described herein.

The processes shown in FIG. 8 are performed by, e.g., the fragment iterator 340 (by issuing tasks to the shader core(s) 300, etc.) as described above.

In step 801, the fragment stream 312 begins execution. The fragment stream 312 can contain some setup state information for the (next) render to be performed which is retrieved and used to configure the render to be performed (step 802).

In step 803, the POP_RENDERPASS instruction 421 (as described above) in the fragment stream 312 is executed, which causes fragment processing to read an entry from the rasterization request FIFO queue 330 (if it is able to do so), thereby (in effect) “receiving” an indication to perform a render (that has been added to the rasterization request FIFO queue 330 by fragment processing, as described above). The render descriptor pointer 451 is used to locate and read the render descriptor 501 (and attributes associated therewith) stored in tiler heap 513, and the present render (fragment processing) to be performed is configured in accordance with the attributes of the descriptor 501, and in accordance with the further render data 453

As mentioned above, the (settings for the) present render to be performed is then configured in accordance with the render control flags 452 (of the indication to perform the render that has been read from the rasterisation request FIFO queue 330).

As will be discussed further below, if the last_render_flag is set to FALSE (indicating that the present render to be performed is a non-final incremental render for the render output being generated, and hence that one or more further (subsequent) renders will be performed for the render output), then the results of the present render that is to be performed are stored as an intermediate output (so they can be retrieved and used in a further (subsequent) (incremental) render that is performed). If the first_render_flag is set to FALSE (indicating that one or more (incremental) renders have already been performed for the render output, previous to the present (incremental) render to be performed), then this means that the results of a previous render will have been stored as an (intermediate) output, and thus those results should be (and are) retrieved and used when performing the (present) render.

Thus, in step 805, in order to configure the present render to be performed, it is determined whether the first_render_flag is set to TRUE.

If the first_render_flag is set to TRUE, meaning that this present render is the first render to be performed for the render output being generated (and hence that no previous renders have been performed for the render output, and hence no render results stored as an intermediate output), then fragment processing is configured to use the (default) application-provided settings to control the loading from memory and clearing of the required data structures (attachments) (colour buffer, depth buffer etc.) in the present render to be performed (step 806).

If, however, the first_render_flag is set to FALSE, meaning that (at least one) previous render has already been performed for the render output being generated (and hence that (and as will be discussed further below) the result of the previous render will have been stored as an intermediate output (attachments), then the fragment processing is configured to force the loading of this intermediate output (attachments) from memory to be used in the present render to be performed (step 807).

In step 808, in order to configure the present render to be performed, it is determined whether the last_render_flag is set to TRUE.

If the last_render_flag is set to TRUE, meaning that the present render to be performed is the final render for the render output (and hence that no subsequent renders will take place in respect of the render output being generated), then fragment processing is configured to use (default) application-provided settings to control the saving of the results of the present render (attachments) to memory (step 809). In this case, the result of the present render that is generated will correspond to the full (“complete”) render output, which is to be stored as a final output.

If, however, the last_render_flag is set to FALSE, meaning that the present render to be performed is a non-final incremental render for the render output, and hence that at least one further (subsequent) render will be performed for the render output, then fragment processing is configured to force saving of the results of the present render (attachments) to memory as an intermediate output (so that it can be loaded in the next render to be performed) (step 810).

Now that the settings of the present render (fragment processing) to be performed have been configured in accordance with the render control flags (metadata), the RUN_FRAGMENT instruction 422 in the fragment stream 312 is executed, thereby causing fragment processing operations (i.e. the render) to be performed using the configured settings (step 811), including controlling the loading/storing of data structures (attachments) in accordance with the configured settings (as discussed above).

Thus the results of the fragment processing (render) are stored in memory 6. In the case where the last_render_flag is set to FALSE, the results are stored as an intermediate output (such that they can be retrieved and used in a further (subsequent) render. In the case where the last_render_flag is set to TRUE, meaning that the results of the render correspond to the full “complete” render output, this full “complete” render output is stored as final output (in accordance with the application provided settings, as discussed above).

As discussed above, the fragment processing operations (render) is performed using the results of geometry processing that are stored in the tiler heap 313, i.e. the pointer array 502, primitives 503 and varyings 504 (which are located by fragment processing using the render pointer descriptor 451).

After the render has been performed, and the results of the render stored to memory (either as an intermediate output (in the case wherein the last_render_flag is set to FALSE) or as a final (“complete”) render output (in the case wherein the last_render_flag is set to TRUE, as discussed above) then the memory in tiler heap portion (chunk) 500) storing the descriptor 501 and results of the geometry processing pass (i.e. pointer array 502, primitives 503 and varyings 504) is released (so that it can be re-used to store a new render descriptor and results of a further geometry processing pass).

The SYNC_SET instruction 423 is executed, with the outcome dependent on whether or not the last_render_flag is set to TRUE or FALSE (step 812).

If the last_render_flag is set to TRUE, meaning the full “complete” render output has been generated and stored as a final output, then the SYNC_SET instruction 423 is executed, and a notification is sent to the host that rendering is completed, and any further work to be performed by the graphics processor that is dependent (on the (“complete”) render output having been generated) can be performed (i.e. is “unblocked”) (step 813).

If the last_render output is set to FALSE, meaning that the results of the render output have been stored as an “intermediate output” and at least one further geometry processing pass (and hence at least one further render) will need to be carried out for the render output being generated, then the fragment processing returns to perform step 802, i.e. configure the next render to be performed, and step 803, i.e. to read (or attempt to read) an entry (i.e. indication to perform the (next) render) from the rasterization request FIFO queue 330 by executing the POP_RENDERPASS instruction, etc. and so on.

In the embodiment discussed above, the fragment processing operations (shown in FIG. 8) are carried out when a fragment (command) stream 312, that has been built up and provided by the host processor, is executed (by command stream processor 310).

However, rather than using a (dedicated) fragment stream, it would instead be possible to perform the fragment processing operations using a (infinite) fragment processing loop, e.g. that is created at the start of a renderpass that is being performed, wherein in this fragment processing loop the fragment processing continuously reads (or attempts to read) an entry (i.e. indication to perform a render) from the rasterisation request FIFO queue 330 and then (in response) performs a render in accordance with the indication, and then returns to read (or attempts to read) a further entry from the rasterisation request FIFO queue 330, etc. and so on, with this fragment processing loop continuing indefinitely until it is explicitly terminated.

In this case, rather than setup state information for a render to be performed being provided to fragment processing in a fragment stream (e.g. as shown in step 802 of FIG. 8), all necessary state information for the render would instead be provided to fragment processing by geometry processing, e.g. either as “further render data” 453 that is contained in the indication to perform a render, or as attributes of the render descriptor 501 that is set up by geometry processing and accessed by fragment processing (as discussed above).

In another embodiment, instead of using a (dedicated) fragment stream, a command “subroutine” (pointer thereto) is specified when the BEGIN_RENDERPASS instruction 411 is executed, with this subroutine (pointer) then being added in the entry to the rasterisation request FIFO queue 330 (along with pointer to the render descriptor and the first_render_flag and last_render_flag) when providing the indication to perform the render. Fragment processing continuously reads (or attempts to read) an entry to from the rasterisation request FIFO queue 330, and then (in response) executes the subroutine to perform the render.

In this case, a separate subroutine is specified for each render that is to be performed, and so once a subroutine has been executed, fragment processing returns to read (or attempt to read) a next entry from rasterisation request FIFO queue 330. The subroutine skips the SYNC_SET instruction, unless the render being performed is the last render for the render output being generated.

As will be appreciated from the above, the technology described herein, in its embodiments at least, can provide a more efficient and flexible framework for triggering renders (both “normal” (i.e. full) and “incremental”) in a graphics processor. This is achieved, in the embodiments of the technology described herein at least, by a geometry processing part of the graphics processor providing an indication to a fragment processing part of the graphics processor to perform a render for a render output being generated, the indication being associated with metadata that can be set to indicate that the render to be performed is a first render to be performed for the render output that is being generated, and with metadata that can be set to indicate that the render to be performed is a final render to be performed for the render output that is being generated. The metadata is sufficient to specify to the fragment processing part they type of render to be performed (i.e. whether the render is a either (a) a normal “full” render for the render output being generated, or (b) an incremental render in a sequence of incremental renders for the output being generated (and, in the case of (b), whether the incremental render is (i) the first, (ii) the last, or (iii) neither the first nor the last (i.e. an intermediate) incremental render in the sequence of incremental renders being performed for the render output)), and the fragment processing part can then perform the render in accordance with the metadata that is provided.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor to execute a tile-based rendering process to generate a render output, the tile-based rendering process comprising a geometry processing part wherein geometry processing is performed for a render output being generated, and a fragment processing part wherein the result of the geometry processing by geometry processing part is subjected to fragment processing to render tiles of the render output being generated, the method comprising:
the geometry processing part providing an indication to the fragment processing part to perform a render for a render output being generated, the indication being associated with metadata that can be set to indicate that the render to be performed is a first render to be performed for the render output that is being generated, and with metadata that can be set to indicate that the render to be performed is a final render to be performed for the render output that is being generated; and
the fragment processing part, in response to the indication, performing a render for the render output being generated in accordance with the metadata.

2. The method of claim 1, comprising the geometry processing part:
providing an indication to the fragment processing part to perform a render when geometry processing for the render output that is being generated is completed; and
setting the metadata to indicate that the render to be performed is a final render for the render output being generated.

3. The method of claim 1, comprising the geometry processing part:
providing an indication to the fragment processing part to perform a render when there is a shortage of memory available to the geometry processing part for storing the result of geometry processing for a render output being generated; and
setting the metadata to indicate that the render output to be performed is not a final render for the render output being generated.

4. The method of claim 1, wherein the graphics processor comprises a first in first out (FIFO) queue provided between the graphics processing part and the fragment processing part, and the method comprises the geometry processing parting providing the indication to perform a render to the fragment processing part by adding the adding the indication to the FIFO queue.

5. The method of claim 1, comprising the geometry processing part setting the metadata to indicate that the render to be performed is a first render for the render output being generated when beginning a first geometry processing pass for the render output being generated.

6. The method of claim 1, comprising the geometry processing part:
generating and storing to memory a descriptor comprising state information for allowing a render to be performed; and
providing as the indication to perform a render that is provided to fragment processing part a pointer usable to locate the descriptor in memory;
and the fragment processing part:
using the pointer to retrieve the descriptor from memory; and
performing the render for the render output being generated using the state information.

7. The method of claim 6, further comprising:
the geometry processing part storing the results of the geometry processing at a location in memory that is identifiable from the descriptor; and
the fragment processing part using the pointer to retrieve the results of the geometry processing and subjecting them to fragment processing when performing the render for the render output being generated.

8. The method of claim 6, further comprising:
the fragment processing part releasing memory storing the descriptor and the results of the geometry processing after performing the render for the render output being generated.

9. The method of claim 1, comprising when the metadata indicates that the render to be performed is not a final render for the render output being generated, the fragment processing part storing the result of the render that is performed as an intermediate output so that it can be used by the fragment processing part when performing a subsequent render for the render output.

10. The method of claim 1, comprising when the metadata indicates that that the render to be performed is not a first render for the render output being generated, the fragment processing part, when performing the render, loading the result of a previous render that has been stored as intermediate output and using it when performing the render.

11. A graphics processor configured to execute a tile-based rendering process to generate a render output, the graphics processor comprising:
one or more geometry processing circuits configured to perform geometry processing for a render output being generated; and
one or more fragment processing circuits configured to subject the result of geometry processing to fragment processing to render tiles of a render output;
wherein the geometry processing circuits comprise a processing circuit configured to provide an indication to the fragment processing circuits to perform a render for a render output being generated, the indication being associated with metadata that can be set to indicate that the render to be performed is a first render to be performed for the render output that is being generated, and with metadata that can be set to indicate that the render to be performed is a final render to be performed for the render output that is being generated;
and wherein the fragment processing circuits comprise a processing circuit configured to, in response to the indication, cause a render for the render output being generated to be performed in accordance with the metadata.

12. The graphics processor of claim 11, wherein the processing circuit of the geometry processing circuits is configured to provide an indication to the fragment processing part to perform a render when geometry processing for the render output that is being generated is completed, and set the metadata to indicate that the render to be performed is a final render for the render output being generated.

13. The graphics processor of claim 11, wherein the processing circuit of the geometry processing circuits is configured to provide an indication to the fragment processing part to perform a render when there is a shortage of memory available to the geometry processing part for storing the result of geometry processing, and set the metadata to indicate that the render output to be performed is not a final render for the render output being generated.

14. The graphics processor of claim 11 further comprising a first in first out (FIFO) queue provided between the geometry processing circuits and the fragment processing circuits;
and wherein the processing circuit of the geometry processing circuits is configured to provide the indication to perform a render to the fragment processing part by adding the adding the indication to the FIFO queue.

15. The graphics processor of claim 11, wherein the geometry processing part comprises a descriptor-generating circuit configured to generate and store to memory a descriptor comprising state information for allowing a render to be performed, and the processing circuit of the geometry processing circuits is configured to provide as the indication to perform a render that is provided to fragment processing part a pointer usable to locate the descriptor in memory; and
wherein the fragment processing circuits comprise a descriptor-retrieving circuit configured to use the pointer to retrieve the descriptor from memory, and the processing circuit of the fragment processing circuits is configured to cause the render to be performed for the render output being generated using the state information.

16. The graphics processor of claim 15, wherein the one or more geometry processing circuits are configured to store the results of geometry processing at a location in memory that is identifiable from the descriptor; and
wherein the fragment processing circuits comprise a results-fetching circuit configured to use the to use the pointer to retrieve the results of the geometry processing;
and wherein the one or more fragment processing circuits are configured to subject the retrieved results of geometry processing to fragment processing when the render is performed.

17. The graphics processor of claim 15, wherein the fragment processing circuits comprise a memory-releasing circuit configured to release memory storing the descriptor and the results of the geometry processing after the render for the render output being generated has been performed.

18. The graphics processor of claim 11, wherein the one or more fragment processing circuits are configured to, when the metadata indicates that the render to be performed is not a final render for the render output being generated, store the result of the render that is performed as an intermediate output so that it can be used by the one or more fragment processing circuits when performing a subsequent render for the render output.

19. The graphics processor of claim 11, wherein the one or more fragment processing circuits are configured to, when the metadata indicates that that the render to be performed is not a first render for the render output being generated, when performing the render, load the result of a previous render that has been stored as intermediate output and use it when performing the render.

20. A non-transitory computer readable storage medium storing computer software code which, when executing on at least one processor, performs a method of operating a graphics processor to execute a tile-based rendering process to generate a render output, the tile-based rendering process comprising a geometry processing part wherein geometry processing is performed for a render output being generated, and a fragment processing part wherein the result of the geometry processing by geometry processing part is subjected to fragment processing to render tiles of the render output being generated, the method comprising:
the geometry processing part providing an indication to the fragment processing part to perform a render for a render output being generated, the indication being associated with metadata that can be set to indicate that the render to be performed is a first render to be performed for the render output that is being generated, and with metadata that can be set to indicate that the render to be performed is a final render to be performed for the render output that is being generated; and
the fragment processing part, in response to the indication, performing a render for the render output being generated in accordance with the metadata.
